(19) United States
(12) Patent Application Publication
(10) Pub. No.: US 2026/0019443 A1
(43) Pub. Date: Jan. 15, 2026

(54) System and Method for Analyzing Cyber Security Postures and Real-Time Asset Validation for Critical Infrastructure

(71) Applicant: ABB Schweiz AG, Baden (CH)

(72) Inventors: Sourav Kunal, Bhagalpur (IN); Sukumara Thangavelu, Bangalore (IN); Aagam Shah, Gandhinagar (IN); Tejas Pandya, Rajkot (IN); Tulasi Ananda, Bangalore (IN); Abhijit-H R, Mysore (IN); Vipulkumar Ghughriwala Parth, Surat (IN)

(73) Assignee: ABB Schweiz AG, Baden (CH)

(21) Appl. No.: 19/335,400

(22) Filed: Sep. 22, 2025

Related U.S. Application Data
(63) Continuation of application No. PCT/IB2024/055073, filed on May 24, 2024.

(30) Foreign Application Priority Data
May 24, 2023 (IN) 202341036065

(51) Int. Cl. H04L 9/40; G06N 20/00

(52) U.S. Cl. CPC H04L 63/1433; G06N 20/00

(57) ABSTRACT

A system and method for analyzing cybersecurity posture for an OT infrastructure includes categorizing a plurality of devices of one or more plants into levels, based on an exposure of each device to a communication network, identifying CVEs of components of the plurality of devices; assigning a severity value to the one or more CVEs of components and determining a plant cybersecurity posture score for the one or more plants; computing a critical infrastructure cybersecurity posture score for the OT infrastructure; and applying remediation to one or more vulnerable components based on a prioritization sequence.

### CROSS-REFERENCE TO RELATED APPLICATIONS

The instant application claims priority to International Patent Application No. PCT/IB2024/055073, filed May 24, 2024, and to Indian Patent Application No. 202341036065, filed May 24, 2023, each of which is incorporated herein in its entirety by reference.

### FIELD OF THE DISCLOSURE

The present disclosure generally relates to cybersecurity and, more particularly, to systems and methods for analyzing cybersecurity postures and real-time asset validation of connected devices for critical infrastructure such as operation technology (OT) infrastructure.

### BACKGROUND OF THE INVENTION

Critical infrastructure includes vast network of commercial buildings, data centers, highways, connecting bridges and tunnels, mining and minerals, railways, renewables, substation automation, energy distribution automation, power plant automation, grid automation, energy, smart grid, water and wastewater treatment, necessary to maintain normalcy. To protect high impact core infrastructure from cybersecurity attacks, a key requirement is to determine cybersecurity in real-time and whether it is falling under the standard.

### BRIEF SUMMARY OF THE INVENTION

The present disclosure overcomes one or more shortcomings of the prior art and provides additional advantages discussed throughout the present disclosure. Additional features and advantages are realized through the techniques of the present disclosure. Other embodiments and aspects of the disclosure are described in detail herein and are considered a part of the claimed disclosure.

In an embodiment, a method for analyzing cybersecurity posture for an operation technology (OT) infrastructure is disclosed. The method includes categorizing a plurality of devices of plurality of plants of the OT infrastructure into a plurality of levels, based on an exposure of each device to a communication network. The plurality of levels indicates vulnerability of the plurality of devices to a cyber threat, and the vulnerability to the cyber threat increases with the increase in the level. The method further includes identifying one or more common vulnerabilities and exposures (CVEs) of components of the plurality of devices, at each level, utilizing Bill of Material (BoM) corresponding to each device. The method further includes assigning a severity value to the one or more CVEs of components based on one or more databases of the plurality of devices present at each level. The one or more databases are associated with vulnerability. The method further includes calculating a sum of severities based on the number of CVEs of components present at each level and the associated severity values. The method further includes determining a plant cybersecurity posture score (PCPS) for the plurality of plants based on the sum of severities, a number of devices in each level, and a compensation value. Then the method includes computing a critical infrastructure cybersecurity posture score (CICPS) for the OT infrastructure based on the determined PCPS of the plurality of plants.

In another embodiment, a method for prioritizing remediation of common vulnerabilities and exposures (CVEs) of components of a plurality of devices is disclosed. The method includes receiving a critical infrastructure cybersecurity posture score (CICPS) of an OT infrastructure. The method includes retrieving classification of the one or more CVEs of components of the plurality of devices from a classification database. The method includes generating a prioritization sequence for remediation of one or more vulnerable components of each plant based on the classification of the one or more CVEs of components. The method includes applying remediation to the one or more vulnerable components based on the generated prioritization sequence to modify the CICPS of the OT infrastructure.

In yet another embodiment, a system for analyzing cybersecurity posture for an operation technology (OT) infrastructure is disclosed. The system includes a memory and at least one processor coupled to the memory. The at least one processor is configured to categorize a plurality of devices of plurality of plants of the OT infrastructure into a plurality of levels, based on an exposure of each device to a communication network. The at least one processor is configured to identify one or more common vulnerabilities and exposures (CVEs) of components of the plurality of devices, at each level, utilizing Bill of Material (BoM) corresponding to each device. The at least one processor is configured to assign a severity value to the one or more CVEs of components based on one or more databases. The one or more databases are associated with vulnerability. The at least one processor is configured to calculate a sum of severities based on the number of CVEs of components present at each level and the associated severity values. The at least one processor is configured to determine a plant cybersecurity posture score (PCPS) for the plurality of plants based on the sum of severities, a number of devices in each level, and a compensation value. The at least one processor is configured to compute a critical infrastructure cybersecurity posture score (CICPS) for the OT infrastructure based on the determined PCPS of the plurality of plants.

In yet another embodiment, a system to analyze cybersecurity posture for an operation technology (OT) infrastructure is disclosed. The system includes a memory and at least one processor. The at least one processor is configured to receive a critical infrastructure cybersecurity posture score (CICPS) of the OT infrastructure. The at least one processor is configured to retrieve classification of one or more CVEs of components of the plurality of devices from a classification database. The at least one processor is configured to generate a prioritization sequence for remediation of one or more vulnerable components of each plant based on the classification of the one or more CVEs of components. Further, the at least one processor is configured to apply remediation to the one or more vulnerable components based on the generated prioritization sequence to modify the CICPS of the OT infrastructure.

In yet another embodiment, a method for real-time asset validation of connected devices in an operation technology (OT) infrastructure is disclosed. The method includes monitoring a plurality of parameters associated with the connected devices in the OT infrastructure. The plurality of parameters at least comprises device critical parameters, cybersecurity parameters, and functional safety parameters. The method then includes applying at least one natural language processing (NLP) model on one or more parameter, among a first set of the plurality of monitored parameters to extract textual information. The first set of the plurality of monitored parameters includes at least one of software bill of materials (SBOM), audit logs, system logs and event logs, device critical parameter logs, device behavior data. Then, the method includes performing feature extraction using Extended Berkeley Packet Filter (eBPF) on a second set of the plurality of monitored parameters and the second set of the plurality of monitored parameters include at least one of low-level system data and network activity information from the connected devices. Finally, the method includes integrating the extracted textual information with the extracted features, comparing the integrated information with vulnerabilities and abnormal behavior-based signatures, and detecting vulnerability and/or anomaly based on the comparison.

In yet another embodiment, for real-time asset validation of connected devices in an operation technology (OT) infrastructure is disclosed. The system includes a memory and at least one processor. The at least one processor is configured to monitor a plurality of parameters associated with the connected devices in the OT infrastructure. The plurality of parameters at least comprises device critical parameters, cybersecurity parameters, and functional safety parameters. The at least one processor is then configured to apply at least one natural language processing (NLP) model on one or more parameter, among a first set of the plurality of monitored parameters to extract textual information. The first set of the plurality of monitored parameters includes at least one of software bill of materials (SBOM), audit logs, system logs and event logs, device critical parameter logs, device behavior data. Then, the at least one processor is configured to perform feature extraction using Extended Berkeley Packet Filter (eBPF) on a second set of the plurality of monitored parameters and the second set of the plurality of monitored parameters include at least one of low-level system data and network activity information from the connected devices. Finally, the at least one processor is configured to integrate the extracted textual information with the extracted features, compare the integrated information with vulnerabilities and abnormal behavior-based signatures, and detect vulnerability and/or anomaly based on the comparison.

### BRIEF DESCRIPTION OF THE SEVERAL VIEWS OF THE DRAWING(S)

FIG. 1 is a block diagram representation of categorization of a plurality of devices present in a critical infrastructure, in accordance with an embodiment of the present disclosure.

FIG. 2 is a schematic representation of a critical infrastructure, in accordance with an embodiment of the present disclosure.

FIG. 3 is a block diagram representation for training a machine learning model, in accordance with another embodiment of the present disclosure.

FIG. 4 is a block diagram of a system for computing a critical infrastructure cybersecurity posture score (CICPS) for an operation technology (OT) infrastructure, in accordance with an embodiment of the present disclosure.

FIG. 5A is a flowchart illustrating a method for analyzing cybersecurity posture for an operation technology (OT) infrastructure, in accordance with an embodiment of the present disclosure.

FIG. 5B is a flowchart illustrating a method for analyzing cybersecurity posture for the operation technology (OT) infrastructure, in accordance with another embodiment of the present disclosure.

FIG. 6 is a flowchart illustrating a method for prioritizing remediation of common vulnerabilities and exposures (CVEs) of components of a plurality of devices present in the plant 103 and the critical infrastructure 101, in accordance with an embodiment of the present disclosure.

FIG. 7 is a block diagram representation for managing vulnerability and/or anomaly in connected devices in operation technology (OT) infrastructure, in accordance with another embodiment of the present disclosure.

FIG. 8 is a block diagram of a system for real-time asset validation of connected devices in an operation technology (OT) infrastructure, in accordance with an embodiment of the present disclosure.

FIG. 9 is a flowchart illustrating a method for real-time asset validation of connected devices in an operation technology (OT) infrastructure, in accordance with an embodiment of the present disclosure.

FIG. 10 is a block diagram representation of asset integrity verification, in accordance with an embodiment of the present disclosure.

### DETAILED DESCRIPTION OF THE INVENTION

In the present document, the word “exemplary” is used herein to mean “serving as an example, instance, or illustration”. Any embodiment or implementation of the present subject matter described herein as “exemplary” is not necessarily to be construed as preferred or advantageous over other embodiments.

While the disclosure is susceptible to various modifications and alternative forms, specific embodiments thereof has been shown by way of example in the drawings and will be described in detail below. It should be understood, however, that it is not intended to limit the disclosure to the particular forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device, or method that comprises a list of components or steps does not include only those components or steps but may include other components or steps not expressly listed or inherent to such setup or device or method. In other words, one or more elements in a device or system or apparatus proceeded by “comprises . . . a” does not, without more constraints, preclude the existence of other elements or additional elements in the device or system or apparatus.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

The terminologies “critical infrastructure” and “operation technology (OT) infrastructure or environment” have been interchangeably used throughout the specification. The terminologies “Bill of Material (BoM)” and “Software Bill of Materials (SBoM)” have been interchangeably used throughout the specification.

To protect high impact core infrastructure from cybersecurity attacks, a key requirement is to determine quality of cybersecurity in real-time and whether the quality of cybersecurity is falling under the standard. There is no such technique or automated approach to prioritize the remediation process and check for the increase in the cybersecurity posture in real time. So far innumerable cybersecurity scoring systems have been proposed to determine and establish the severity of vulnerability for general purpose computing systems. Unfortunately, these cybersecurity scoring systems cannot be implemented onto the systems present in critical infrastructure in operation technology environment.

Presently, in plant/site most of the time security configurations of assets are overlooked, as it exposes the device assets, and opens larger attack surface for attackers. This exposes plant's network and its assets to the public internet. Neither the customer nor the developers are aware about these vulnerabilities or loose configurations. Most of the plants are still running with insecure device configuration.

One of the solutions to the above problem is that the engineer can go for patching devices one by one, which is quite time consuming, thereby also increasing business downtime. Further, when a device's health gets affected due to malicious activity, there is a need for continuous monitoring of such events as well.

However, there are no ready-made or tailored solutions available for engineers/administrators to view all these abnormalities together for the connected devices in OT plant through a secured automated approach. The available solutions which calculate the scores based on some agents are too complex and can easily be manipulated by the users. The integrity of such solutions cannot be justified.

In view of the foregoing discussion, there exists a need in the art to provide a method and a system which overcomes the stated problems and provide a technique for efficiently analyzing cybersecurity postures of OT infrastructure and for real-time asset validation of connected devices in OT infrastructure.

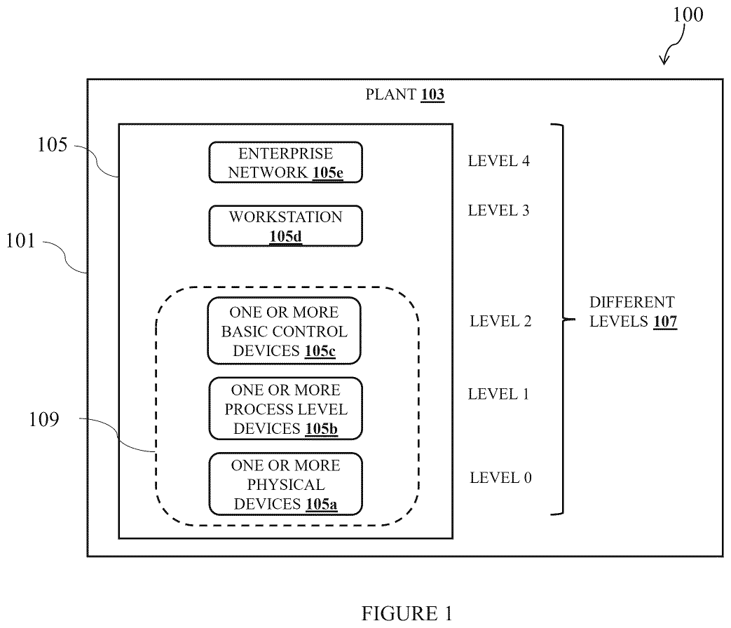

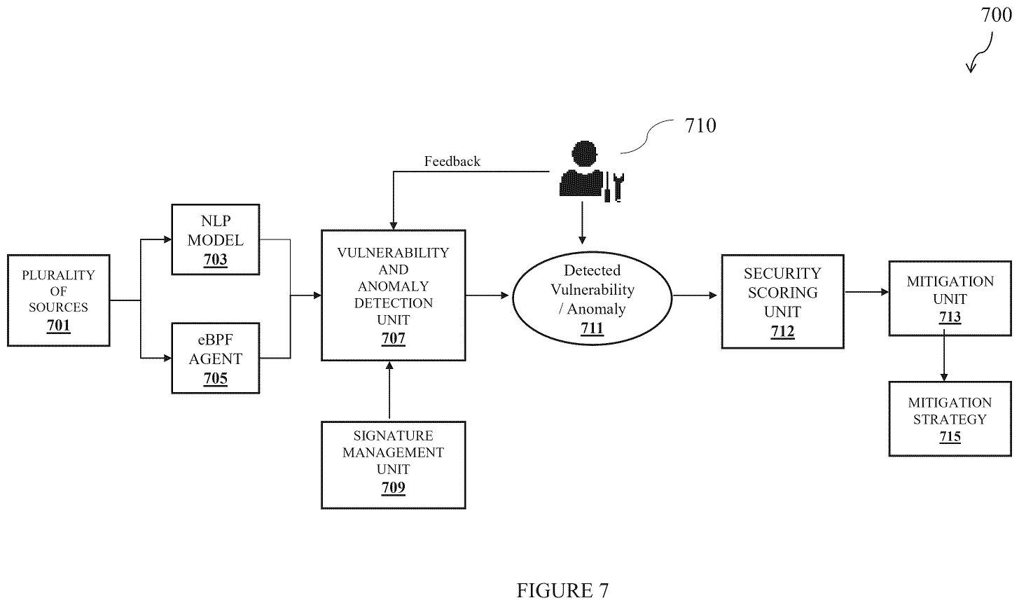

In an aspect of the present disclosure, a passive multi layered approach for calculating cyber security postures in OT infrastructure is discussed with reference to FIGS. 1 to 6. In another aspect of the present disclosure, OT real-time monitoring and live asset validation of connected devices with proactive cyber security posture scoring is discussed with reference to FIGS. 7 to 10.

Referring now to FIG. 1, a block diagram representation 100 of categorization of a plurality of devices 105 present in plant 103 is illustrated, in accordance with an embodiment of the present disclosure. The term “critical infrastructure’ as used herein refers to an operation technology (OT) infrastructure. The operational technology infrastructure (herein after, OT infrastructure) includes processes and equipment used to manage, control, and monitor operational technology. In general, the OT infrastructure may include commercial buildings, data centers, mining and minerals, renewables, railways, water and wastewater treatment, oil and gas, electric, aviation, manufacturing, and transportation.

In an embodiment, the critical infrastructure 101 may include one or more plants (not shown in FIG. 1). In an example, the critical infrastructure 101 includes the plant 103 (as shown in FIG. 1). The plant 103 includes a plurality of devices 105. The plurality of devices 105 of the plant 103 are categorized into a plurality of levels 107 based on public exposure of respective devices. In an exemplary embodiment, the public exposure may comprise exposure—to a communication network via internet, public Wi-Fi, and the like. The plurality of levels 107 indicates vulnerability of the plurality of devices 105 to a cyber threat. The vulnerability to the cyber threat increases with the increase in the level. The plurality of levels 107 corresponds to at least: a first level “LEVEL 0”, a second level “LEVEL 1”, a third level “LEVEL 2”, a fourth level “LEVEL 3”, and a fifth level “LEVEL 4”. The plurality of devices 105 of the plant 103 are categorized into the plurality of levels 107 based on an exposure of each device of the plurality of devices 105 to the communication network. The first level “LEVEL 0” is minimally exposed to the communication network. The fifth level “LEVEL 4” is maximally exposed to the communication network i.e. internet. The exposure to the communication network increases with the increase in the number of the plurality of levels 107. For example, the exposure of the third level “LEVEL 2” to the communication network is more than the exposure of the second level “LEVEL 1” to the communication network.

Considering that the plurality of devices 105 may belong to the Industrial Control System (ICS). Then, the plurality of devices 105 at the first level “LEVEL 0” comprises one or more physical devices 105a. The one or more physical devices 105a may be one or more of: sensors, actuators, breakers, transformers, switch gears, and motors. The plurality of devices 105 at the first level “LEVEL 0” is not limited to the above-mentioned devices. Further, the plurality of devices 105 at the second level “LEVEL 1” may comprise one or more process level devices 105b. The one or more process level devices 105b may include at least one of: remote terminal units (RTU), intelligent relays, smart sensors, and the like. The plurality of devices 105 at the third level “LEVEL 2” may comprise one or more basic control (and/or hardware) devices 105c. The one or more basic control devices 105c include but are not limited to supervisory control and data acquisition (SCADA), human machine interfaces (HMIs), gateways, IoT devices, and data historian. The first level “LEVEL 0”, the second level “LEVEL 1”, and the third level “LEVEL 2” lies in a demilitarized zone (DMZ) 109. The DMZ corresponds to a perimeter network that enables organizations to protect their internal networks. In addition, the DMZ enables organizations to provide access to untrusted networks, such as the internet, while keeping private networks or local-area networks (LANs) secure.

Furthermore, the plurality of devices 105 at the fourth level “LEVEL 3” comprises workstation 105d including engineering workstations. In general, workstation is a special computer designed for technical or scientific applications, intended primarily to be used by a single user. Workstations are commonly connected to a local area network and run multi-user operating systems. The plurality of devices 105 at the fifth level “LEVEL 4” belongs to enterprise network 105e. In general, enterprise networks are composed of local area networks (LANs) that in turn connect to wide area networks (WANs) and server. In an example, the fifth level “LEVEL 4” may include server which is in the enterprise network 105e. The plurality of devices 105 may also include one or more intermediatory devices in between the plurality of levels 107. The one or more intermediatory devices may include, but not limited to, routers, hubs, and gateways. In another non-limiting embodiment, the levels may be defined from LEVELS 1-5, instead of LEVELS 0-4. Further, the number of levels is not limited to above example and the number of levels may be decided based on OT infrastructure or user/administrator preference.

The plurality of devices 105 includes hardware and software components. The software components may be required for hardware components of the respective device. In an example, hardware components may include basic components of the plurality of devices 105 such as sensing unit, processing unit, transceiver unit, power unit, and the like. Further, one or more common vulnerabilities and exposures (CVEs) of components of each device of the plurality of devices 105 are identified. In an example, the one or more CVEs of components correspond to CVEs of software components of each device of the plurality of devices 105. In an example, software component of a device may correspond to MODBUS, DNP, IEC 61850, Profinet, IEC60870-5-104, and the like. However, the software components of the device are not limited to above example and any other software component known to a person skilled in the art is well within the scope of present disclosure. It is assumed that software component of a device is “MODBUS” that is generally used for transmitting information over serial lines between electronic devices. Generally, these types of software components are vulnerable to cyber threats and are marked as “critical” in vulnerability databases. The one or more common vulnerabilities and exposures (CVEs) of components of the plurality of devices 105 are identified at each level of the plurality of levels 107 by utilizing Bill of Material (BoM) corresponding to each device. The Bill of Material (BoM) as used herein refers to Software Bill of Materials (SBoM). In general, SBoM may comprise details of one or more software components being part of and required for performing the necessary functionality through the respective device. Further, the BoM may also comprise details of one or more hardware components of the respective device.

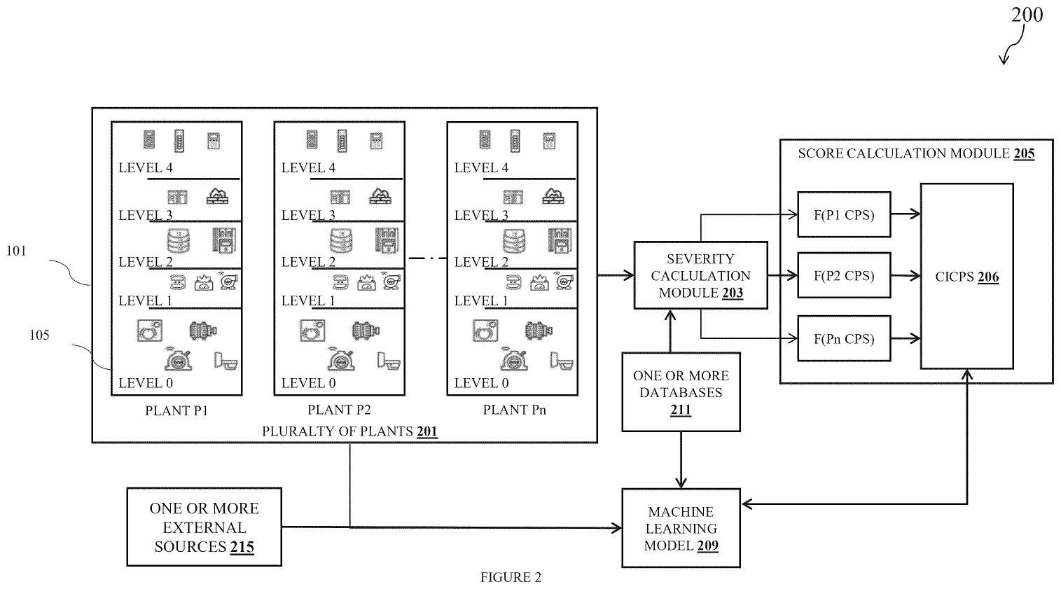

The critical infrastructure 101 is further explained with respect to the plurality of plants in FIG. 2.

FIG. 2 illustrates a schematic representation 200 of the critical infrastructure 101 for determining a plant cybersecurity posture score (PCPS) for a plurality of plants 201 and predicting an output 213 using a machine learning model 209, in accordance with an embodiment of the present disclosure. The schematic representation 200 includes the plurality of plants 201, a severity calculation module 203, a score calculation module 205, the machine learning model 209, one or more databases 211, and one or more external databases 215.

In an example, the plurality of plants 201 includes plant P1, plant P2, and plant Pn. Plant Pn refers to any number of plants. Each plant (P1, P2, . . . Pn) may include the plurality of devices 105 categorized into the plurality of levels 107 (as explained in FIG. 1). Further, the plurality of devices 105 are initially categorized into the plurality of levels 107 for the PCPS calculation of each plant (P1, P2, . . . Pn). Further, the one or more CVEs of software components of the plurality of devices 105 are identified at each level of the plurality of levels 107 by utilizing SBoM corresponding to each device (as explained in FIG. 1). The identified one or more CVEs of components of the plurality of devices 105 at each level are utilized by the severity calculation module 203.

In an embodiment, the severity calculation module 203 may be configured to assign a severity value to the one or more CVEs of components using the one or more databases 211. The one or more databases 211 are associated with vulnerability. In an embodiment, the one or more databases 211 correspond to vulnerability database that acts as a platform aimed at collecting, maintaining, and disseminating information about discovered cybersecurity vulnerabilities of the software components.

In an example, the one or more databases 211 corresponds to National Vulnerability Database (NVD). The NVD is a repository of standards-based vulnerability management data. This data enables automation of vulnerability management, security measurement, and compliance. In an example, the NVD includes databases of security checklist references, security-related software flaws, misconfigurations, product names, impact metrics, and the like.

In another example, the one or more databases 211 corresponds to “VulnDB” database. “VulnDB” database is the most comprehensive and timely vulnerability intelligence database. “VulnDB” database provides actionable information about the latest in security vulnerabilities via an easy-to-use portal, or a RESTful API. In an example, the latest in security vulnerabilities may include broken access control, identification or authentication failures, data integrity failures, backup server online exposure, and the like. In addition, “VulnDB” database allows organizations to search and be alerted on the latest vulnerabilities, both in end-user software and 3rd party libraries or dependencies. However, the one or more databases 211 are not limited to above examples and any database having similar information related to vulnerabilities is well within the scope of present disclosure.

In an embodiment, the one or more databases 211 provides criticality information of the one or more CVEs of components. The criticality information indicates how much critical a software component is. For example, if a software component of any device is searched on the one or more databases 211 (such as NVD), the one or more databases 211 provides the criticality information of the software component as “critical”, “high”, “medium” and “low”. In one non-limiting embodiment, the one or more databases 211 may comprise a look up table for retrieving severity values associated with CVEs of components. In an exemplary aspect, the severity values may range of 0.1 to 10.0 and are categorized into four severity levels: “critical” (9.0-10.0), “high” (7.0-8.0), “medium” (4.0-6.9), and “low” (0.1-3.9). However, the severity value range is not limited to the above example. In one non-limiting embodiment, the above categorization may be as per CVE standard.

In general, a “critical” marked software component may have larger impact on systems or devices that may lead to complete system outage, security breach, complete data loss, and the like. In addition, a software component being marked as “high” criticality software component may have lower impact compared to the “critical” marked software component on a system or device that may lead to severe downgrade of one or more services or operations performed by the system or device, but the overall system or device remains operational. Further, a software component being marked as “medium” criticality software component may lead to moderate loss of application functionality or performance resulting in multiple users impacted in normal functions. Examples may include minor feature/product failure, a convenient workaround exists/minor performance degradation/not impacting production. In addition, a software component being marked as “low” criticality software component may have a negligible impact on users as it may impact functionality that is not frequently used.

In an exemplary embodiment, the criticality information of one or more CVEs of components may be defined based on Confidentiality, Integrity, Availability triad (CIA triad). The CIA triad is a standard model for the development of security systems. The CIA triad includes three parameters “Availability”, “Integrity” and “Confidentiality”. “Confidentiality” refers to a condition where any confidential data should never be shared with third or unauthorized parties. In general, “Integrity” refers to a condition where nothing may be altered in terms of any information that is used in any service or device without detection. “Availability” refers to a condition where everything should be up and running, no matter what happens, the service or device should always respond. Generally, for critical infrastructure or the OT infrastructure, “Availability” is given most importance as the main aim is to keep the device up and running 24×7. Then, comes the “Integrity” as the data needs to be reliable and finally comes the “Confidentiality” whose priority is shifted but the fact that sensitive data needs to be private is still existing. So, the triad is referred as the CIA triad for the critical infrastructure.

The severity calculation module 203 assigns severity value to the one or more CVEs of components based on the criticality information received from the one or more databases 211. The severity value may range between 1 to 4, where 4 refers to “high” and 1 refers to “low”. Further, the severity calculation module 203 is configured to calculate a sum of severities of the plurality of devices 105 based on the number of CVEs of components present at each level and the associated severity values. The sum of severities may be calculated using the following equation:

$$S = {\sum }_{L = 1}^{4} {\sum }_{z = 1}^{n} Z * L , \qquad ( 1 )$$

where S corresponds to the sum of severities, Z corresponds to number of severities, and L corresponds to the severity value.

The severity calculation module 203 is further configured to determine a compensation value for each plant (P1, P2, . . . Pn). In an exemplary embodiment, the compensation value is determined based on a priority factor associated with the plurality of plants 201. The priority factor refers to a parameter that determines which plant is of more importance out of the plurality of plants. In another exemplary embodiment, the compensation value may vary based on several devices categorized in each level of the plurality of levels 107. In an example, it is assumed, the PCPS associated with plant P1 is maximum, however, if the identified one or more CVEs of components contributing to the calculation of the PCPS of the plant P1 is coming from the first level “LEVEL 0” which is at lowest risk to a cyber threat, then, the PCPS may not be completely accurate. The PCPS of the plant P1 may be maximum due to greater number of devices present at the first level “LEVEL 0”. In this case, the compensation value is used to decrease the PCPS of the plant P1 as the first level “LEVEL 0” has lowest risk to a cyber threat. Thus, the compensation value may be utilized to increase the accuracy of the PCPS calculation of the plant.

The calculated sum of severities and the compensation value is sent to the score calculation module 205. The score calculation module 205 is configured to receive the calculated sum of severities and the compensation value of the plurality of plants 201 as input from the severity calculation module 203. In one implementation, the score calculation module 205 is configured to determine the plant cybersecurity posture score (PCPS) for each of the plurality of plants 201 based on the calculated sum of severities, several devices in each level, and the compensation value. In an example, the score calculation module 205 determines the PCPS for the plant P1 as F(P1 CPS). In another example, the score calculation module 205 determines the PCPS for the plant P2 as F(P2 CPS). In yet another example, the score calculation module 205 determines the PCPS for the plant Pn as F(Pn CPS). The PCPS for the plurality of plants 201 is determined based on the following equation:

$$F ( PCPS ) = \frac{1}{{\sum }_{i = 0}^{4} XiSi} + C , \qquad ( 2 )$$

where F(PCPS) corresponds to the plant cybersecurity posture score of the plant (P1, P2, or Pn) and Xi correspond to a level of the plurality of levels 107, Si corresponds to the sum of severities, and C corresponds to the compensation value.

Further, the score calculation module 205 is configured to compute a critical infrastructure cybersecurity posture score (CICPS) 206 for the OT infrastructure 101 based on the determined plant cybersecurity posture score (PCPS) of the plurality of plants 201. In an example, the CICPS 206 is determined by averaging the determined PCPS for each plant of the plurality of plants 201.

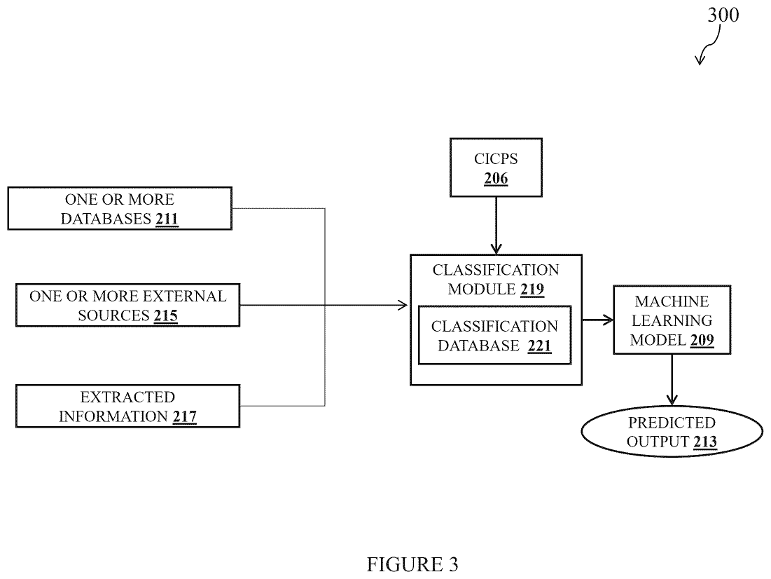

The CICPS 206 is sent to the machine learning model 209. The machine learning model 209 is configured to prioritize remediation of the CVEs of components of the plurality of devices 105 based on a plurality of inputs. The plurality of inputs includes the CICPS 206 received from the score calculation module 205, a set of information received from the plurality of plants 201, and data associated with remediation strategies received from the one or more external sources 215. The one or more external sources 215 may have the solution/remediation strategy related data for reducing the risk and improving the CICPS of the critical infrastructure. In an embodiment, the machine learning model 209 is trained using each of the one or more inputs. Further, the trained machine learning model 209 is configured to generate a predicted output (shown in FIG. 3) The training of the machine learning model 209 is further explained in detail in FIG. 3.

FIG. 3 illustrates a block diagram representation 300 for training the machine learning model 209 to generate a predicted output 213, in accordance with an embodiment of the present disclosure. 213. The predicted output 213 may comprise a prioritization sequence for remediation of one or more vulnerable components. The predicted output 213 may be utilized to improve/update the CICPS 206 of the critical infrastructure 101. The machine learning model 209 may be trained using a classification module 219.

The classification module 219 may be configured to receive the CICPS 206 of the OT infrastructure 101 from the score calculation module 205. Further, the classification module 219 is configured to extract information 217 associated with the one or more CVEs of components of each device from Software Bill of Material (SBoM) corresponding to each device. Furthermore, the classification module 219 is configured to retrieve one or more remediation strategies associated with the one or more CVEs of components from one or more external sources 215. The one or more external sources 215 corresponds to databases associated with the one or more remediation strategies. The one or more external sources 215 provides the one or more remediation strategies for vulnerable components. Moreover, the classification module 219 utilizes the one or more external sources 215. Further, the classification module 219 may be associated with an internal database (not shown in any figure). The internal database comprises results of internal testing performed manually, or source code analysis performed using tools such as Jfrog Xray, BlackDuck Hub and the like. The internal database may comprise Common Vulnerability Scoring System (CVSS) scores and Common Weakness Enumeration (CWE). The classification module 219 is configured to perform classification of the one or more CVEs of components of the plurality of devices 105 based on the CICPS 206, the extracted information 217, the one or more remediation strategies retrieved from the one or more external sources 215, data received from the one or more databases 211, and data received from the internal database. The classification of the one or more CVEs of components of the plurality of devices 105 corresponds to prioritization of the vulnerable components. In an example, the most vulnerable component of the vulnerable components is given the highest priority for remediation. The least vulnerable component of the vulnerable components is given lowest priority for remediation. The one or more CVEs of components of the plurality of devices 105 present at the first level “LEVEL 0” is minimally exposed to the communication network. In addition, the one or more CVEs of components of the plurality of devices 105 present at the fifth level “LEVEL 4” is maximally exposed to the communication network. The exposure to the communication network increases with the increase in the level. For example, the exposure of the third level “LEVEL 2” to the communication network is more than the exposure of the second level “LEVEL 1” to the communication network. In an embodiment, the least vulnerable component may be present at “LEVEL 0” and is given least priority for remediation. However, the most vulnerable component may be present at “LEVEL 4” and is given most priority for remediation.

In an embodiment, the classification module 219 includes a classification database 221. The classification module 219 is configured to store the classification of one or more CVEs of components of each device in the classification database 221.

Based on the classification of the one or more CVEs of the plurality of devices 105, the machine learning model 209 is trained to generate the predicted output 213 that corresponds to the prioritization sequence for remediation of the one or more vulnerable components of each plant. The machine learning model 209 is a part of a system explained further in FIG. 3.

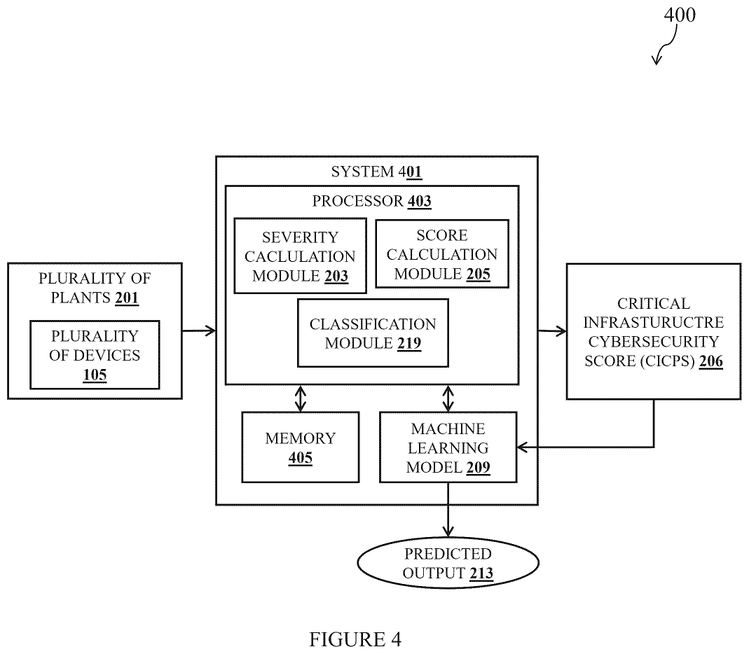

FIG. 4 illustrates a block diagram 400 of a system 401 for computing the critical infrastructure cybersecurity posture score (CICPS) 206 for the operation technology infrastructure 101, in accordance with an embodiment of the present disclosure. In an embodiment, the system 401 can control operations involved in computing the CICPS 206 and generating the predicted output 213.

The system 401 is associated with the plurality of plants 201. The plurality of plants 201 includes the plurality of devices 105 that are categorized into the plurality of levels 107 (as explained in forgoing paragraphs in FIG. 1 of the present disclosure). The system 401 is depicted to include a processor 403, a memory 405, and the machine learning model 209. It shall be noted that, in some embodiments, the system 401 may include more or fewer components than those depicted herein. The various components of the system 401 may be implemented using hardware, software, firmware or any combinations thereof. Further, the various components of the system 401 may be operably coupled with each other. More specifically, various components of the system 401 may be capable of communicating with each other using communication channel media (such as buses, interconnects, etc.). It is also noted that one or more components of the system 401 may be implemented in a single server or a plurality of servers, which are remotely placed from each other.

In one embodiment, the processor 403 may be embodied as a multi-core processor, a single core processor, or a combination of one or more multi-core processors and one or more single core processors. For example, the processor 403 may be embodied as one or more of various processing devices, such as a coprocessor, a microprocessor, a controller, a digital signal processor (DSP), a processing circuitry with or without an accompanying DSP, or various other processing devices including, a microcontroller unit (MCU), a hardware accelerator, a special-purpose computer chip, or the like.

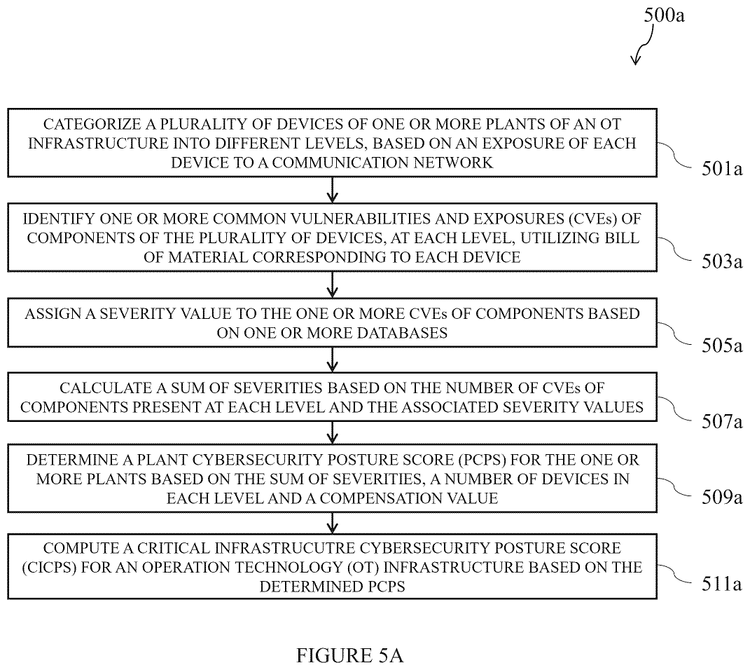

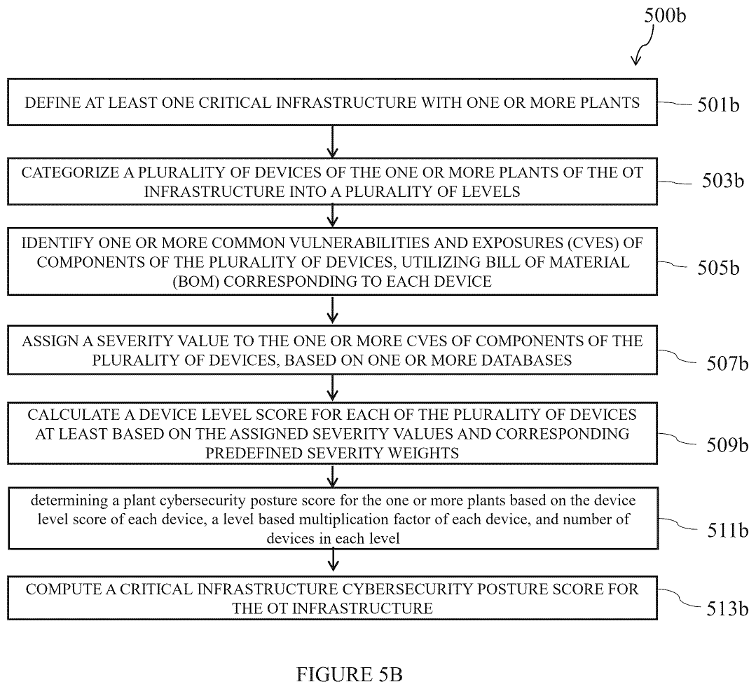

In one embodiment, the memory 405 is capable of storing machine executable instructions, referred to herein as instructions 405. In an embodiment, the processor 403 is embodied as an executor of software instructions. As such, the processor 403 is capable of executing the instructions stored in the memory 405 to perform one or more operations described herein. The memory 405 can be any type of storage accessible to the processor 403 to perform respective functionalities, as will be explained in detail with reference to FIGS. 4 and 5. For example, the memory 405 may include one or more volatile or non-volatile memories, or a combination thereof. For example, the memory 405 may be embodied as semiconductor memories, such as flash memory, mask ROM, PROM (programmable ROM), EPROM (erasable PROM), RAM (random access memory), etc. and the like.

Further, the system 401 is depicted to include the severity calculation module 203, the score calculation module 205, and the classification module 219. In one non-limiting embodiment, the severity calculation module 203, the score calculation module 205, and the classification module 219 may comprise necessary hardware circuitry for performing the functionalities discussed in above embodiments. In one embodiment, the severity calculation module 203, the score calculation module 205, and the classification module 219 may be a part of the processor 403. In another embodiment, the severity calculation module 203, the score calculation module 205, and the classification module 219 are associated with the processor 403 for performing the necessary functionalities. The processor 403 may be in communication with the severity calculation module 203, the score calculation module 205, and the classification module 219.

In an embodiment, the processor 403 is configured to identify the one or more common vulnerabilities and exposures (CVEs) of components of the plurality of devices 105, at each level, utilizing Software Bill of Material (SBoM) corresponding to each device of the plurality of devices 105. In an exemplary aspect, SBoM may comprise details of one or more software components being part and required for performing the necessary functionality of the respective device of the plurality of devices 105. The processor 403 is configured to analyze the spectral representation at one or more frequencies. The processor 403 is configured to assign a severity value to the one or more CVEs of components based on the one or more databases 211 using the severity calculation module 203. The processor 403 is configured to calculate a sum of severities based on the number of CVEs of components present at each level and the associated severity values using the severity calculation module 203. The processor 403 is configured to determine the plant cybersecurity posture score (PCPS) for the plurality of plants 201 based on the sum of severities, a number of devices in each level and the compensation value. Further, the processor 403 is configured to compute the critical infrastructure cybersecurity posture score (CICPS) 206 for the operation technology (OT) infrastructure 101 based on the determined PCPS. The processor 403 may further be configured to receive a critical infrastructure cybersecurity posture score (CICPS) 206 of the OT infrastructure 101. The processor 403 is configured to retrieve classification of one or more CVEs of components of the plurality of devices 105 from the classification database 221. The processor 403 is configured to generate a predicted output 213 using the machine learning model 209. The predicted output 213 corresponds to the prioritization sequence for remediation of the one or more vulnerable components of each plant based on the classification of the one or more CVEs of components. The processor 403 may be configured to apply remediation to the one or more vulnerable components based on the generated prioritization sequence to modify the CICPS 206 of the OT infrastructure 101.

The system 401 may be in operative communication with a storage device (not shown in FIG. 4). In one embodiment, the storage device is configured to store the CICPS 206 and the predicted output 213. In another embodiment, the CICPS 206 and the predicted output 213 may be stored in the memory 405 of the system 401. The storage device may include multiple storage units such as hard disks and/or solid-state disks in a redundant array of inexpensive disks (RAID) configuration. In some embodiments, the storage device may include a storage area network (SAN) and/or a network attached storage (NAS) system. In one embodiment, the storage device may correspond to a distributed storage system, wherein individual storage devices are configured to store information, such as the severity values, the CICPS 206, and the like.

In some embodiments, the storage device is integrated within the system 401. For example, the system 401 may include one or more hard disk drives as the storage device. In other embodiments, the storage device is external to the system 401 and may be accessed by the system 401 using a storage interface (not shown in FIG. 4). The storage interface is any component capable of providing the processor 403 with access to the storage device. The storage interface may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 403 with access to the storage device.

The processor 403 is configured to perform a method for analyzing cybersecurity posture for the operation technology (OT) infrastructure 101. The method is explained next with reference to FIG. 5A, which illustrates a flowchart illustrating a method 500a for analyzing cybersecurity posture for the operation technology (OT) infrastructure 101, in accordance with an embodiment of the present disclosure.

The method 500a depicted in the flow diagram may be executed by, for example, the processor 403 shown in FIG. 4. Operations of the flow diagram, and combinations of operation in the flow diagram, may be implemented by, for example, hardware, firmware, a processor, circuitry and/or a different device associated with the execution of software that includes one or more computer program instructions. The operations of the method 500a are described herein with the help of the processor 403 of the system 401. It is noted that the operations of the method 500a can be described and/or practiced by using one or more processors of a system/device other than the processor 403. To describe the method 500, the reference numerals are used in conjunction with FIGS. 1 to 4. The method 500a starts at operation 501a.

At operation 501a, the method 500a includes categorizing the plurality of devices 105 of plurality of plants 201 of the OT infrastructure 101 into plurality of levels 107, based on an exposure of each device to a communication network. The plurality of levels 107 indicates vulnerability of the plurality of devices 105 to a cyber threat. The vulnerability to the cyber threat increases with the increase in the level. In an exemplary embodiment, the plurality of levels 107 may comprise at least: a first level “LEVEL 0”, a second level “LEVEL 1”, a third level “LEVEL 2”, a fourth level “LEVEL 3”, and a fifth level “LEVEL 4” (shown in FIG. 1). The plurality of devices 105 at the first level “LEVEL 0” comprises one or more physical devices 105a. The one or more physical devices 105a may be one or more of: sensors, actuators, breakers, transformers, switch gears, and motors. The plurality of devices 105 at the first level “LEVEL 0” is not limited to the above-mentioned devices. Further, the plurality of devices 105 at the second level “LEVEL 1” may comprise one or more process level devices 105b. The one or more process level devices 105b may include at least one of: remote terminal units (RTU), intelligent relays, smart sensors, and the like. The plurality of devices 105 at the third level “LEVEL 2” may comprise one or more basic control (and/or hardware) devices 105c. The one or more basic control devices 105c include but are not limited to supervisory control and data acquisition (SCADA), human machine interfaces (HMIs), gateways, IoT devices, and data historian. The first level “LEVEL 0”, the second level “LEVEL 1”, and the third level “LEVEL 2” lies in a demilitarized zone (DMZ) 109. The DMZ corresponds to a perimeter network that enables organizations to protect their internal networks. In addition, the DMZ enables organizations to provide access to untrusted networks, such as the internet, while keeping private networks or local-area networks (LANs) secure.

Furthermore, the plurality of devices 105 at the fourth level “LEVEL 3” comprises workstation 105d including engineering workstations. The workstation is a special computer designed for technical or scientific applications, intended primarily to be used by a single user. Workstations are commonly connected to a local area network and run multi-user operating systems. The plurality of devices 105 at the fifth level “LEVEL 4” belongs to enterprise network 105e. The enterprise network is composed of local area networks (LANs) that in turn connect to wide area networks (WANs) and server. In an example, the fifth level “LEVEL 4” may include server which is in the enterprise network 105e. The plurality of devices 105 may also include one or more intermediatory devices in between the plurality of levels 107. The one or more intermediatory devices may include, but not limited to, routers, hubs, and gateways.

The plurality of devices 105 are categorized into the plurality of levels 107 to calculate the PCPS for each plant of the plurality of plants 201. The plurality of plants 201 includes plant P1, plant P2 and plant Pn (shown in FIG. 2). Plant Pn refers to any number of plants. Each plant (P1, P2, . . . Pn) may include the plurality of devices 105 categorized into the plurality of levels 107. Further, the plurality of devices 105 are initially categorized into the plurality of levels 107 for the PCPS calculation of each plant (P1, P2, . . . Pn). Further, the one or more CVEs of software components of the plurality of devices 105 are identified at each level of the plurality of levels 107 by utilizing SBoM corresponding to each device.

At operation 503a, the method 500a includes identifying the one or more common vulnerabilities and exposures (CVEs) of components of the plurality of devices 105, at each level, utilizing Software Bill of Material (SBoM) corresponding to each device. SBoM may comprise details of one or more software components being part of and required for performing the necessary functionality through the respective device. The identified one or more CVEs of components of the plurality of devices 105 at each level are utilized by the severity calculation module 203 (shown in FIG. 2).

At operation 505a, the method 500a includes assigning a severity value to the one or more CVEs of components of the plurality of devices 105 based on the criticality categorization information received from the one or more databases 211 using the severity calculation module 203. The one or more databases 211 are associated with vulnerability. In an embodiment, the one or more databases 211 correspond to vulnerability database that acts as a platform aimed at collecting, maintaining, and disseminating information about discovered cybersecurity vulnerabilities of the software components. In an embodiment, the one or more databases 211 provides the criticality categorization information of the one or more CVEs of components. For example, if a software component of any device is searched on the one or more databases 211 (such as NVD), the one or more databases 211 provides the criticality categorization information of the software component as “critical”, “high”, “medium” and “low”. In general, a “critical” marked software component may have larger impact on systems or devices that may lead to complete system outage, security breach, complete data loss, and the like. In addition, “high” criticality marked software component may have lower impact compared to “critical” software component on a system or device that may lead to severe downgrade of one or more services or operations performed by the system or device, but the overall system or device remains operational. Further, a “medium” criticality marked software component may lead to moderate loss of application functionality or performance resulting in multiple users impacted in normal functions. Examples may include minor feature/product failure, a convenient workaround exists/minor performance degradation/not impacting production. In addition, “low” criticality software component may have a negligible impact on users as it may impact functionality that is not frequently used.

At operation 507a, the method 500a includes calculating the sum of severities based on the number of CVEs of components present at each level and the associated severity values using the severity calculation module 203. The sum of severities may be calculated based on the equation (1) discussed in the above embodiment.

The calculated sum of severities is sent to the score calculation module 205. The severity calculation module 203 is further configured to determine the compensation value for each plant of the plurality of plants 201. In an embodiment, the compensation value is determined based on the priority factor associated with the plurality of plants 201. The priority factor refers to a parameter that determines which plant is at highest or lowest risk to a cyber threat. In another embodiment, the compensation value varies based on a number of devices categorized in each level of the plurality of levels 107. In an example, it is assumed, the PCPS associated with plant P1 is maximum, however, if the identified one or more CVEs of components contributing to the calculation of the PCPS of the plant P1 is coming from the first level “LEVEL 0” which is at lowest risk to a cyber threat, then, the PCPS may not be completely accurate. The PCPS of the plant P1 may be maximum due to greater number of devices present at the first level “LEVEL 0”. In this case, the compensation value is used to decrease the PCPS of the plant P1 as the first level “LEVEL 0” has lowest risk to a cyber threat. Thus, the compensation value may be utilized to increase the accuracy of the PCPS calculation of the plant.

At operation 509a, the method 500a includes determining the plant cybersecurity posture score (PCPS) for the plurality of plants 201 based on the sum of severities, the number of devices in each level, and the compensation value with facilitation of score calculation module 205. The score calculation module 205 is configured to receive the calculated sum of severities and the compensation value of each plant as input from the severity calculation module 203. In an example, the score calculation module 205 determines the PCPS for the plant P1 as F(P1 CPS). In another example, the score calculation module 205 determines the PCPS for the plant P2 as F(P1 CPS). In yet another example, the score calculation module 205 determines the PCPS for the plant Pn as F(Pn CPS). The PCPS for the plurality of plants 201 is determined based on the equation (2) discussed in above embodiment.

At operation 511a, the method 500a includes computing the critical infrastructure cybersecurity posture score (CICPS) 206 for the OT infrastructure 101 based on the determined PCPS of the plurality of plants 201. In an example, the CICPS 206 is determined by averaging the determined PCPS for each plant of the plurality of plants 201. The CICPS 206 is sent to the machine learning model 209. The machine learning model 209 is configured to prioritize remediation of the CVEs of components of the plurality of devices 105 based on a plurality of inputs. The plurality of inputs includes the CICPS 206 received from the score calculation module 205, a set of information received from the plurality of plants 201, and data associated with remediation strategies received from the one or more external sources 215. The one or more external sources 215 may have the solution/remediation strategy related data for reducing the risk and improving the CICPS of the critical infrastructure. In an embodiment, the machine learning model 209 is trained using each of the one or more inputs. Further, the trained machine learning model 209 is configured to generate the predicted output 213 that corresponds to the prioritization sequence for remediation of the one or more vulnerable components of each plant.

The disclosed method with reference to FIG. 5A, or one or more operations of the flow diagram 500a may be implemented using software including computer-executable instructions stored on one or more computer-readable media (e.g., non-transitory computer-readable media, such as one or more optical media discs, volatile memory components (e.g., DRAM or SRAM), or non-volatile memory or storage components (e.g., hard drives or solid-state non-volatile memory components, such as Flash memory components) and executed on a computer (e.g., any suitable computer, such as a laptop computer, net book, Web book, tablet computing device, smart phone, or other mobile computing device). Such software may be executed, for example, on a single local computer.

FIG. 5B illustrates a flowchart illustrating a method 500b for analyzing cybersecurity posture for the operation technology (OT) infrastructure 101, in accordance with another embodiment of the present disclosure.

The method 500b depicted in the flow diagram may be executed by, for example, the processor 403 shown in FIG. 4. Operations of the flow diagram, and combinations of operation in the flow diagram, may be implemented by, for example, hardware, firmware, a processor, circuitry and/or a different device associated with the execution of software that includes one or more computer program instructions. The operations of the method 500b are described herein with help of the processor 403 of the system 401. It is noted that the operations of the method 500b can be described and/or practiced by using one or more processors of a system/device other than the processor 403. To describe the method 500b, the reference numerals are used in conjunction with FIGS. 1 to 4. The method 500b starts at operation 501.

At operation 501b, the method 500b includes defining at least one critical infrastructure with one or more plants. The defining of the at least one critical infrastructure may include receiving a user input comprising a number of critical infrastructures, a number of plants in each critical infrastructure, a number of devices present in each plant, priority of each plant, and level information of each device.

At operation 503b, the method 500b includes categorizing a plurality of devices of the one or more plants of the OT infrastructure into a plurality of levels, based on an exposure of each device to a communication network. The plurality of levels 107 indicates vulnerability of the plurality of devices 105 to a cyber threat. The vulnerability to the cyber threat increases with the increase in the level. In an exemplary embodiment, the plurality of levels 107 may comprise at least: a first level “LEVEL 0”, a second level “LEVEL 1”, a third level “LEVEL 2”, a fourth level “LEVEL 3”, and a fifth level “LEVEL 4” (shown in FIG. 1). In an embodiment, the categorizing a plurality of devices may be based on user/administrator input provided while defining the OT infrastructure.

At operation 505b, the method 500b includes identifying one or more common vulnerabilities and exposures (CVEs) of components of the plurality of devices, utilizing Bill of Material (BoM) corresponding to each device. SBoM may comprise details of one or more software components being part of and required for performing the necessary functionality through the respective device. The identified one or more CVEs of components of the plurality of devices 105 at each level are utilized by the severity calculation module 203 (shown in FIG. 2).

At operation 507b, the method 500b includes assigning a severity value to the one or more CVEs of components of the plurality of devices, based on one or more databases, the one or more databases being associated with vulnerability. Each severity value is mapped with a respective predefined severity weight. The one or more databases 211 are associated with vulnerability. In an embodiment, the one or more databases 211 correspond to vulnerability database that acts as a platform aimed at collecting, maintaining, and disseminating information about discovered cybersecurity vulnerabilities of the software components. In an embodiment, the one or more databases 211 provides the criticality categorization information of the one or more CVEs of components.

In an exemplary embodiment, the severity values may be within the range of 0.1 to 10.0 and are categorized into four severity levels: critical (9.0-10.0), high (7.0-8.0), medium (4.0-6.9), and low (0.1-3.9). These values may be extracted or retrieved from open-source databases as discussed in the above aspect. In another exemplary embodiment, the severity values may be provided by the user/administrator.

At operation 509b, the method 500b includes calculating a device level score for each of the plurality of devices based on the assigned severity values and corresponding predefined severity weights using the severity calculation module 203. The device level score may be calculated based on the below equation (3).

$${S}_{d} = 100 - \frac{( {\sum }_{i}^{n} V {D}_{i} \times W {L}_{i} ) \times 100}{( {\sum }_{i} W {L}_{i} ) \times 10 + ∈} \qquad ( 3 )$$

where S_{d} corresponds to the device level score, VDᵢ corresponds to the severity value, WLᵢ corresponds to the predefined severity weight, and ∈ corresponds to a constant value to have non-zero denominator.

The severity weight may be predefined for a range of severity values based on a user input. In an example, critical values are assigned weight of 4, high values are assigned weight of 2.5, medium values are assigned weight of 1.5, and low values are assigned weight of 1. However, these weights are exemplary and may vary based on the OT infrastructure and user/administrator preference.

At operation 511b, the method 500b includes determining a plant cybersecurity posture score for the one or more plants based on the device level score of each device, a level-based multiplication factor of each device, and number of devices in each level using score calculation module 205. The plant cybersecurity posture score may be determined based on the below equation (4).

$${S}_{p} = ( \frac{{\sum }_{i}^{5} d \times ( {Sd}_{i} \times {W}_{Lsdi} )}{100 \times ( {\sum }_{L} ( {W}_{L} \times No of {devices}_{L} ) ) + ∈} ) \times 100 \qquad ( 4 )$$

where Sₚ corresponds to the plant cybersecurity posture score, Sdᵢ corresponds to the device level score of each device present in the plant, WLSdᵢ corresponds to the level-based multiplication factor, and ∈ corresponds to a constant value for having non-zero denominator. The level-based multiplication factor may be predefined for each level of the plurality of levels.

At operation 513b, the method 500b includes computing a critical infrastructure cybersecurity posture score for the OT infrastructure based on the determined plant cybersecurity posture score of the one or more plants and assigned priority of each plant. In an example, the critical infrastructure cybersecurity posture score may be determined by averaging the determined plant cybersecurity posture score for each plant of the plurality of plants and their respective priorities. The critical infrastructure cybersecurity posture score is computed based on the below equation (5):

$${S}_{ci} = ( \frac{{\sum }_{p} ( {S}_{p} \times {priority}_{p} )}{100 \times ( {\sum }_{p} ( p \times No of plants with {priority}_{p} ) ) + ∈} ) \times 100 \qquad ( 5 )$$

where S_{ci} corresponds to the plant cybersecurity posture score, Spᵢ corresponds to the plant cybersecurity posture score of the critical infrastructure, priorityₚ corresponds to the priority assigned to each plant, and ∈ corresponds to a constant value.

In one non-limiting embodiment, the critical infrastructure cybersecurity posture score may be provided to the machine learning model 209. The machine learning model 209 is configured to prioritize remediation of the CVEs of components of the plurality of devices 105 based on a plurality of inputs. The plurality of inputs includes the critical infrastructure cybersecurity posture score received from the score calculation module 205, a set of information received from the plurality of plants 201, and data associated with remediation strategies received from the one or more external sources 215. The one or more external sources 215 may have the solution/remediation strategy related data for reducing the risk and improving the critical infrastructure cybersecurity posture score of the critical infrastructure. In an embodiment, the machine learning model 209 is trained using each of the one or more inputs. Further, the trained machine learning model 209 is configured to generate the predicted output 213 that corresponds to the prioritization sequence for remediation of the one or more vulnerable components of each plant.

The disclosed method with reference to FIG. 5B, or one or more operations of the flow diagram 500b may be implemented using software including computer-executable instructions stored on one or more computer-readable media (e.g., non-transitory computer-readable media, such as one or more optical media discs, volatile memory components (e.g., DRAM or SRAM), or non-volatile memory or storage components (e.g., hard drives or solid-state non-volatile memory components, such as Flash memory components) and executed on a computer (e.g., any suitable computer, such as a laptop computer, net book, Web book, tablet computing device, smart phone, or other mobile computing device). Such software may be executed, for example, on a single local computer.

The method 500b discussed in above embodiments may be understood based on the example below. In an exemplary aspect, a critical infrastructure is defined by a user input. The user input includes: number of critical infrastructures the number of plants=1, number of devices in plant 1=3, levels for device 1 (1-5)=5, severities for various components of device 1: 9.8, 9.6, 9.1, 5.0, 7.1, 2.3, 0.8, level for device 2 (1-5):3, severities for various components of device 2: 7.2, 9.1, 7.5, 0.9, 1.5, 3.3, 9.1, level for device 3 (1-5):2, severities for various components of device 3: 6.6, 2.2, 7.7. Then, using the equation (3) d1 device level score=100−[[(9.8×4)+(9.6×4)+(9.1×4)+(5.0×1.5)+(7.1×2.5)+(2.3×1)+(0.8×1)]/((4+4+4+1.5+2.5+1+1)×10)]×100]=100−79.08=20.92. Similarly, d2 device level score=100−70.85=29.15, and d3 device level score=100−62.70=37.3.

A level based multiplication factor may be considered for calculating a plant cybersecurity posture score. Let level 5 has level based multiplication factor of 10, level 4 has level based multiplication factor of 7, level 3 has level based multiplication factor of 5, level 2 has level based multiplication factor of 2, and level 1 has level based multiplication factor of 1. Then, using the equation (4), the plant cybersecurity posture score for plant 1 is 25.27. If the priority assigned to plant 1 is 5, then the critical infrastructure cybersecurity posture using equation (5) is ((25.27×5)×100)/((5×1)×100)=25.27. However, the critical infrastructure cybersecurity posture may change based on number of plants and their respective priorities.

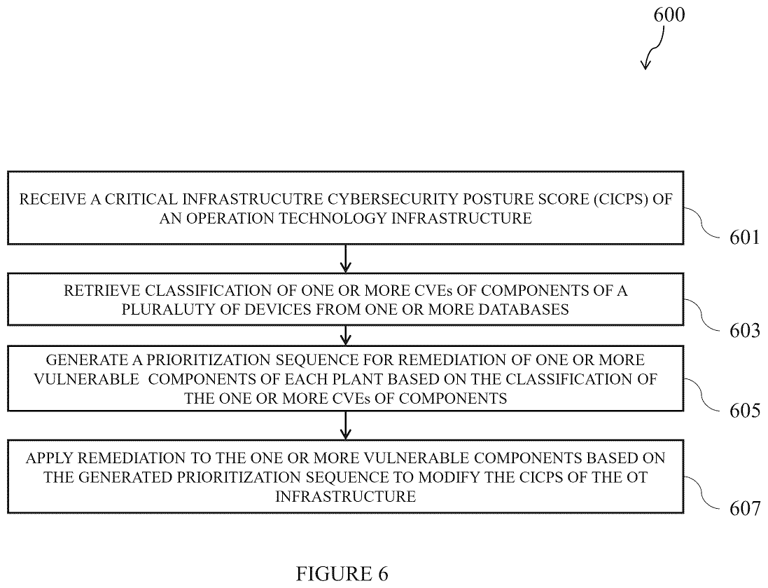

FIG. 6 illustrates a flowchart illustrating a method 600 for prioritizing remediation of the CVEs of components of the plurality of devices 105 present in the critical infrastructure 101, in accordance with an embodiment of the present disclosure. The operations of the method 600 are described herein with help of the processor 403 of the system 401. It is noted that the operations of the method 600 can be described and/or practiced by using one or more processors of a system/device other than the processor 403. To describe the method 600, the reference numerals are used in conjunction with FIGS. 1 to 4. The method 600 starts at operation 601.

At operation 601 of the method 600, the critical infrastructure cybersecurity posture score (CICPS) 206 of the OT infrastructure is received by a processor, such as, the processor 403 shown and explained with reference to FIG. 4. As already explained, the processor 403 may be embodied within the system 401.

At operation 603 of the method 600, classification of the one or more CVEs of components of the plurality of devices 105 is retrieved by the processor 403 from the classification database 221 using the classification module 219. The classification module 219 is configured to perform the classification of the one or more CVEs of components of the plurality of devices 105 based on the CICPS 206, the extracted information 217, the one or more remediation strategies retrieved from the one or more external sources 215, and data received from the one or more databases 211. The classification of the one or more CVEs of components of the plurality of devices 105 corresponds to prioritization of the vulnerable components. In an example, the most vulnerable component of the vulnerable components is given highest priority for remediation. The least vulnerable component of the vulnerable components is given lowest priority for remediation. The one or more CVEs of components of the plurality of devices 105 present at the first level “LEVEL 0” is minimally exposed to the communication network. In addition, the one or more CVEs of components of the plurality of devices 105 present at the fifth level “LEVEL 4” is maximally exposed to the communication network. The exposure to the communication network increases with the increase in the level. For example, the exposure of the third level “LEVEL 2” to the communication network is more than the exposure of the second level “LEVEL 1” to the communication network. In an embodiment, the least vulnerable component may be present at “LEVEL 0” and is given least priority for remediation. However, the most vulnerable component may be present at “LEVEL 4” and is given most priority for remediation. Based on the classification of the one or more CVEs of the plurality of devices 105, the machine learning model 209 is trained to generate the predicted output 213 that corresponds to the prioritization sequence for remediation of the one or more vulnerable components of each plant. The machine learning model 209 is trained using the classification module 219. The machine learning model 209 is configured to prioritize remediation of the CVEs of components of the plurality of devices 105 based on a plurality of inputs. The plurality of inputs includes the CICPS 206 received from the score calculation module 205, a set of information received from the plurality of plants 201, and data associated with remediation strategies received from the one or more external sources 215. The one or more external sources 215 may have the solution/remediation strategy related data for reducing the risk and improving the CICPS of the critical infrastructure.

At operation 605 of the method 600, the prioritization sequence for remediation of one or more vulnerable components of each plant is generated. The prioritization sequence is generated based on the classification of the one or more CVEs of components using trained the machine learning model 209. Further, the prioritization sequence generated by the trained machine learning model 209 is the predicted output 213. In addition, the predicted output 213 may comprise the prioritization sequence for remediation of one or more vulnerable components. The predicted output 213 may be utilized to improve/update the CICPS 206 of the critical infrastructure 101.

At operation 607 of the method 600, remediation to the one or more vulnerable components is applied based on the generated prioritization sequence to modify the CICPS 206 of the OT infrastructure 101. The sequence of operations of the method 600 need not be necessarily executed in the same order as they are presented. Further, one or more operations may be grouped together and performed in the form of a single step, or one operation may have several sub-steps that may be performed in parallel or in a sequential manner.

The disclosed method with reference to FIG. 6, or one or more operations of the flow diagram 600 may be implemented using software including computer-executable instructions stored on one or more computer-readable media (e.g., non-transitory computer-readable media, such as one or more optical media discs, volatile memory components (e.g., DRAM or SRAM), or non-volatile memory or storage components (e.g., hard drives or solid-state non-volatile memory components, such as Flash memory components) and executed on a computer (e.g., any suitable computer, such as a laptop computer, net book, Web book, tablet computing device, smart phone, or other mobile computing device). Such software may be executed, for example, on a single local computer.

FIG. 7 illustrates a block diagram representation for managing vulnerability and/or anomaly in connected devices in operation technology (OT) infrastructure, in accordance with another embodiment of the present disclosure.

In an embodiment, data is collected from plurality of sources 701. The data collection may include monitoring of plurality of parameters associated with the connected devices in the OT infrastructure. The plurality of sources 701 may include software bill of materials (SBOM), audit logs, system logs and event logs, device critical parameters (or protection and control parameters), device behavior data, low-level system data, and network activity information.

The device critical parameters may comprise voltage and power configuration parameters. The Tracking voltage levels and power configuration in any Industrial Engineering Departments (IEDs) helps in identifying fluctuations or abnormalities that might cause electrical issues in future.

The device critical parameters may comprise network traffic and bandwidth usage that helps in identifying unusual patterns, potential security threats, or network congestion. In one non-limiting embodiment, the Extended Berkeley Packet Filter (eBPF) agents may monitor these parameters and notify the administrator about any abnormalities.

The device critical parameters may further comprise performance metrics as processing speed, response times, and throughput, which are tracked to ensure optimal device performance. In one non-limiting aspect, these metrics may be generated based on the existing device behavior data and devices may be periodically monitored generating the performance metrics.

The device critical parameters may further comprise error rates and alarms for which device operational log and access logs are continuously checked/monitored. An increase in errors or frequent alarms may indicate potential issues.

The device critical parameters may further comprise health and status of the device for which the hardware and software components are monitored to identify any vulnerable or obsolete component. In one non-limiting embodiment, the hardware and software components health may be monitored using Hardware BoM (HBoM) and Software BoM (SBoM).

The device critical parameters may further comprise security events and logs, which are monitored to detect any suspicious activities or potential cyber threats. In an embodiment, the device critical parameters may also comprise device communication security data. The device communication security is monitored using device configuration. Disruptions or anomalies in communication may indicate a potential security breach or a malfunction.

The device critical parameters may further comprise firmware and software versions, which is tracked using the SBoM to ensure that devices are running the latest, most secure, and stable versions. The device critical parameters may also comprise access and authentication logs, which are tracked to know who is accessing the OT devices and to detect any unauthorized access attempts. Further, the device critical parameters may include maintenance schedules for tracking the regular maintenance tasks and to prevent unexpected failures.

The data collected from plurality of sources 701 may be provided to the NLP model 703 and the eBPF agent 705. The NLP model 703 may be configured to apply text analysis on one or more parameters present in the collected data to extract textual information. The one or more parameters may include software bill of materials (SBOM), audit logs, system logs and event logs, device critical parameter logs, device behavior data. The text analysis may include preprocessing audit logs, system logs, and event logs. Then, performing tokenizing, removing stop words, and performing stemming/lemmatization to extract meaningful information. The text analysis may further include performing entity recognition, in which the entities are identified along with users and actions from the textual information. The text analysis may also include applying topic modeling techniques which can be utilized to identify common themes or issues within the logs. In one non-limiting embodiment, the NLP model 703 may be retrained with an additional dataset for improving the extracted textual information.

The eBPF agent 705 may be configured to performing feature extraction using Extended Berkeley Packet Filter (eBPF) on one or more parameters in the collected data. The feature extraction may include extracting features from the CPU loading, memory usage, and network activity information from the connected devices.

The extracted textual information and the extracted features are then provided to the vulnerability and anomaly detection unit 707 for detecting vulnerability and/or anomaly 711. The vulnerability and anomaly detection unit 707 may receive the vulnerabilities and abnormal behavior-based signatures from the signature management unit 709. These signatures may be then compared with the extracted textual information and the extracted features to detect vulnerability and/or anomaly 711. In one non-limiting embodiment, the vulnerabilities and abnormal behavior-based signatures may be updated based on the evolving threats and the vulnerability and anomaly detection unit 707 may be configured to detect the evolving threats based on the updated vulnerabilities and abnormal behavior-based signatures.

In an embodiment, the vulnerabilities and abnormal behavior-based signatures may be generated by the signature management unit 709 based on the known vulnerabilities and abnormal behavior identified in historical data. These signatures may be then used to detect anomalies/vulnerabilities in the real-time data. In one non-limiting embodiment, the vulnerabilities and abnormal behavior-based signatures are dynamically updated based on the evolving threat landscape. This is achieved by actively monitoring the new vulnerabilities and abnormal behavior. In another non-limiting embodiment, the vulnerabilities and abnormal behavior-based signatures may be customized by the user for specific threats relevant to their environment.

In one non-limiting embodiment, the vulnerability and anomaly detection unit 707 may comprise an adaptive machine learning model for detecting anomalies/vulnerabilities 711 in the real-time data. The vulnerability and anomaly detection unit 707 may receive expert administrator feedback on the detected anomalies/vulnerabilities 711 for distinguishing between false positives and actual threats. The feedback may be incorporated into the dataset to train the adaptive machine learning model. Further, the adaptive machine learning model may be trained at regular intervals to improve the accuracy of the anomalies/vulnerabilities detection. In one non-limiting embodiment, supervised learning, unsupervised learning, and reinforcement learning may be used for training the adaptive machine learning model.

In one non-limiting embodiment, various loss functions can be used to measure the difference between predicted and actual outcomes, depending on the task (e.g., anomaly detection, classification). For regression tasks, the present disclosure employs a mean squared error (MSE), which calculates the average of the squared differences between predicted and actual values. In another exemplary embodiment, mean absolute error (MAE) may also be utilized, particularly for regression, as it computes the average of absolute differences, providing resilience against outliers. In yet another exemplary embodiment, Huber Loss, a combination of MSE and MAE, adjusting their behavior based on a hyperparameter to balance outlier robustness and smoothness effectively.

Further, optimization techniques such as stochastic gradient descent or its variants are used to minimize the loss function during training. In an exemplary embodiment, hyperparameters like learning rate, batch size, and regularization parameters are tuned during training to optimize model performance.

In one non-limiting aspect of the present disclosure, the security scoring unit 712 may be further configured to determine values of the device critical parameters and the cybersecurity parameters based on the monitoring, assign a weight to each of the device critical parameters and the cybersecurity parameters, and calculate plant security score based on the values of the device critical parameters, the cybersecurity parameters, and the assigned weights. The plant security score may be then used to calculate the overall plant security posture. This may help the plant owner to improve the plant security posture, as discussed in above embodiments.

In an embodiment, a flexible dynamic scoring system may be provided to the plant owners flexibility to add weights in the parameters. Consider protection and control parameters (device critical parameters) as DC and cybersecurity parameters as SP. The plant owner adding weights in DC=(DC1×W1)+(DC2×W2) . . . and plant owner adding weights in SP=(SP1×U1)+(SP2×U2) . . . . Then, plant security score (PSS) may be calculated based on below equation (6).

$$PSS = \frac{\begin{matrix}( ( DC 1 \times W 1 ) + ( DC 2 \times W 2 ) ) \times ( X \% ) + \\ ( ( SP 1 \times U 1 ) + ( SP 2 \times U 2 ) ) \times ( Y \% )\end{matrix}}{( ( W 1 + W 2 ) \times ( U 1 + U 2 ) )} \qquad ( 6 )$$

In one non-limiting of the present disclosure, the user/plant owner may decide on the percentage for device critical parameters and cybersecurity parameters.

In one non-limiting embodiment, an alert generation unit (not shown) may be configured to generate an alert for the expert administrator, if the PSS is not within a predefined threshold range.

The detected vulnerability and/or anomaly 711 may be provided to the mitigation unit 713. The mitigation unit 713 may comprise a plurality of mitigation strategies for vulnerability and/or anomaly. In one non-limiting embodiment, the mitigation unit 713 may retrieve a plurality of mitigation strategies from one or more external sources and recommend at least one mitigation strategy for the detected vulnerability and/or anomaly. The expert administrator may implement the mitigation strategy for the detected vulnerability and/or anomaly. In another non-limiting embodiment, the mitigation unit 713 may recommend at least one mitigation strategy for the detected vulnerability and/or anomaly to improve the plant security score (PSS).

Thus, the present disclosure provides a comprehensive, adaptive, and integration of device critical parameters as an efficient solution to cybersecurity challenges compared to traditional approaches. Further, the present disclosure integrates diverse data sources, analyzes complex information, and continuously learn from expert feedback, thereby enhancing threat detection and mitigation capabilities, and making it a valuable asset in cybersecurity defense strategies. In addition, expert feedback collection, periodic model re-training, and dynamic signature updates ensure the effectiveness and adaptability of the system.

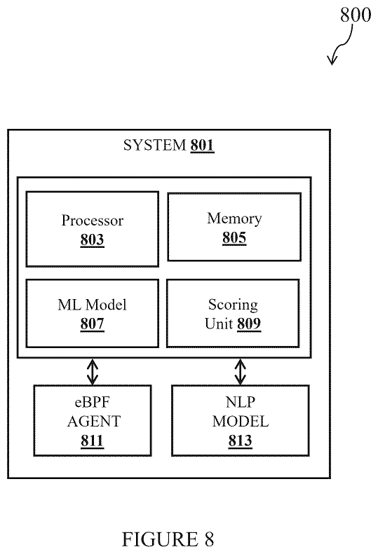

FIG. 8 is a block diagram 800 of a system 801 for real-time asset validation of connected devices in an operation technology (OT) infrastructure, in accordance with an embodiment of the present disclosure.

In an embodiment of the present disclosure, the system 801 may comprise a processor 803, a memory 805, a machine learning (ML) model 807, a scoring unit 809, an eBPF agent 811, and a natural language processing (NLP) model 813, in communication with each other.

In one embodiment, the processor 803 may be embodied as a multi-core processor, a single core processor, or a combination of one or more multi-core processors and one or more single core processors. For example, the processor 803 may be embodied as one or more of various processing devices, such as a coprocessor, a microprocessor, a controller, a digital signal processor (DSP), a processing circuitry with or without an accompanying DSP, or various other processing devices including, a microcontroller unit (MCU), a hardware accelerator, a special-purpose computer chip, or the like.

The system 801 is associated with the plurality of plants 201. The plurality of plants 201 includes the plurality of devices 105 that are categorized into the plurality of levels 107 (as explained in forgoing paragraphs in FIG. 1 of the present disclosure). The system 801 is depicted to include processor 803, memory 805, ML model 807, scoring unit 809, an eBPF agent 811, and NLP model 813 coupled to each other. It shall be noted that, in some embodiments, the system 801 may include more or fewer components than those depicted herein.

The various components of the system 801 may be implemented using hardware, software, firmware or any combinations thereof. Further, the various components of the system 801 may be operably coupled with each other. More specifically, various components of the system 801 may be capable of communicating with each other using communication channel media (such as buses, interconnects, etc.). It is also noted that one or more components of the system 801 may be implemented in a single server or a plurality of servers, which are remotely placed from each other.

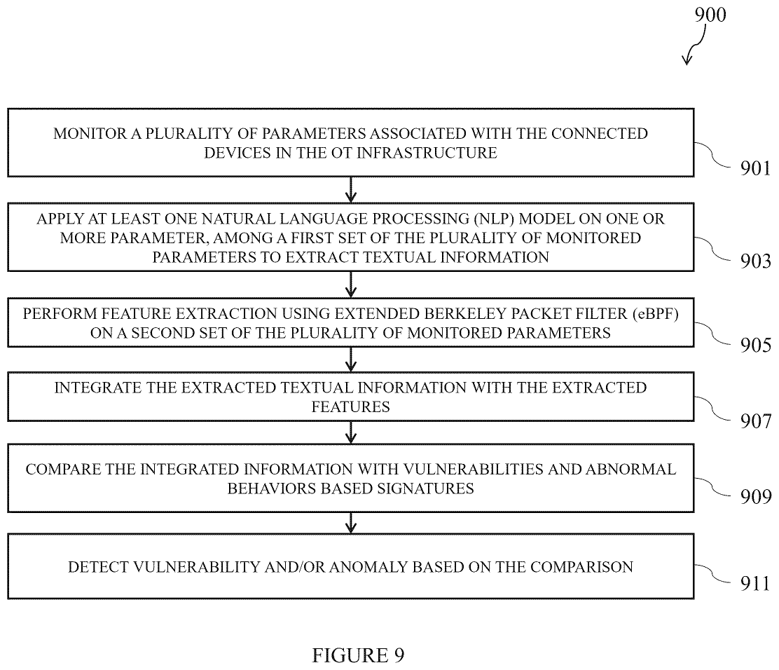

In one embodiment, the memory 805 can store machine executable instructions, referred to herein as instructions 805. In an embodiment, the processor 803 is embodied as an executor of software instructions. As such, the processor 803 can execute the instructions stored in the memory 805 to perform one or more operations described herein. The memory 805 can be any type of storage accessible to the processor 803 to perform respective functionalities, as will be explained in detail with reference to FIGS. 8 and 9. For example, the memory 805 may include one or more volatile or non-volatile memories, or a combination thereof. For example, the memory 805 may be embodied as semiconductor memories, such as flash memory, mask ROM, PROM (programmable ROM), EPROM (erasable PROM), RAM (random access memory), etc. and the like.

In an embodiment of the present disclosure, the processor 803 may be configured to monitor a plurality of parameters associated with the connected devices in the OT infrastructure. The plurality of parameters may at least comprise device critical parameters, cybersecurity parameters, and functional safety parameters. In one non-limiting embodiment, the processor 803 may be configured to monitor one or more parameters actively by interacting with the live systems/device and monitor remaining of the plurality of parameters passively without interacting with the live system/devices.

In an embodiment of the present disclosure, the plurality of parameters may include voltage and power configuration parameters, network traffic and bandwidth, performance metrics, error rates and alarms, device health and status, security events, communication integrity data, firmware and software versions, access and authentication logs, and maintenance schedule data. However, the plurality of parameters is not restricted to the above examples, and other parameters related to devices within the plant in OT infrastructure are well within the scope of the present disclosure. In one non-limiting embodiment, the plurality of parameters may be classified into device critical parameters, cybersecurity parameters, and functional safety parameters, as discussed in the above embodiments.

The processor 803 may be configured to apply at least one natural language processing (NLP) model 813 on one or more parameter, among a first set of the plurality of monitored parameters to extract textual information. The extraction of textual information may be performed as discussed in the above embodiments. The first set of the plurality of monitored parameters includes at least one of software bill of materials (SBOM), audit logs, system logs and event logs, device critical parameter logs, device behavior data. The first set of the plurality of monitored parameters are passively monitored without interacting with live system. Thus, these parameters contribute towards determination of the passive security posture.

In an embodiment, the NLP model 813 may be trained with plurality of training dataset associated with similar plant environment for extraction of the textual information from the plurality of training dataset. In one non-limiting embodiment of the present disclosure, the NLP model 813 may be retrained based on the feedback received from the administrator. The retraining may include receiving feedback on the extracted textual information, applying the feedback on the training dataset to generate an updated training dataset and retraining the NLP model based on the updated training dataset. The retrained NLP model 813 may improve the accuracy of the vulnerability and/or anomaly detection.

The processor 803 may be configured to performing feature extraction using Extended Berkeley Packet Filter (eBPF) agent 811 on a second set of the plurality of monitored parameters. The second set of the plurality of monitored parameters includes at least one of low-level system data and network activity information taken from the connected devices in the OT infrastructure.

The processor 803 may be then configured to integrate the extracted textual information with the extracted features. In an embodiment, most of the extracted textual information and the extracted features are in json/xml format. The integration may include the conversion of the extracted features which are not in json/xml format into json/xml format using a parser.

The processor 803 may be then configured to compare the integrated information with vulnerabilities and abnormal behavior-based signatures and detect vulnerability and/or anomaly based on the comparison. The vulnerabilities and abnormal behavior-based signatures may be generated based on the known vulnerabilities and abnormal behavior identified in historical data. These signatures may be then used to detect anomalies/vulnerabilities in the real-time data. In one non-limiting embodiment, the vulnerabilities and abnormal behavior-based signatures are dynamically updated based on the evolving threat landscape. This is achieved by actively monitoring the new vulnerabilities and abnormal behavior in the OT environment. In another non-limiting embodiment, the vulnerabilities and abnormal behavior-based signatures may be customized by the user for specific threats relevant to their OT environment.

In one non-limiting embodiment, the processor 803 may be then configured to detect vulnerability and/or anomaly using machine learning (ML) model 807 for detecting anomalies/vulnerabilities 711 in the real-time data. The ML model 807 may be an adaptive machine learning model for detecting anomalies/vulnerabilities. The ML model 807 may be trained with vulnerabilities and abnormal behavior-based signatures, which were observed previously. The ML model 807 may receive expert administrator feedback on the detected anomalies/vulnerabilities to distinguish between false positives and actual threats. The feedback may be incorporated into the dataset to train the ML model 807. Further, the ML model 807 may be trained at regular intervals to improve the accuracy of the anomalies/vulnerabilities detection. In one non-limiting embodiment, supervised learning, unsupervised learning, and reinforcement learning may be used for training the adaptive machine learning model, as discussed in above embodiments.

The processor 803 may be further configured to retrieve a plurality of mitigation strategies from one or more external sources and recommend at least one mitigation strategy for the detected vulnerability and/or anomaly. In one non-limiting embodiment, the expert administrator may implement the mitigation strategy for the detected vulnerability and/or anomaly.

In one non-limiting aspect of the present disclosure, the processor 803 may be further configured to determine values of the device critical parameters and the cybersecurity parameters based on the monitoring, assign a weight to each of the device critical parameters and the cybersecurity parameters, and calculate, using a scoring unit 809, plant security score based on the values of the device critical parameters, the cybersecurity parameters, and the assigned weights. The plant security score may be then used to calculate the overall plant security posture. This may help the plant owner to improve the plant security posture, as discussed in the above embodiments.

In an embodiment, a flexible dynamic scoring system may be provided to the plant owners flexibility to add weights in the parameters. Consider protection and control parameters (device critical parameters) as DC and cybersecurity parameters as SP. The plant owner adding weights in DC=(DC1×W1)+(DC2×W2) . . . and plant owner adding weights in SP=(SP1×U1)+(SP2×U2) . . . . Then, plant security score (PSS) may be calculated based on equation (6).

In one non-limiting of the present disclosure, the user/plant owner may decide on the percentage for device critical parameters and cybersecurity parameters.

In an embodiment of the present disclosure, one or more mitigation strategies may be recommended by the processor 803 to improve the PSS. In another embodiment, the processor 803 may be configured to generate an alert if the PSS is not within the predetermined threshold range.

Thus, the system 801 provides a comprehensive, adaptive, and integration of device critical parameters as an efficient solution to cybersecurity challenges compared to traditional approaches. Further, the system 801 integrates diverse data sources, analyzes complex information, and continuously learn from expert feedback, thereby enhancing threat detection and mitigation capabilities, and making it an asset in cybersecurity defense strategies. In addition, expert feedback collection, periodic model re-training, and dynamic signature updates ensure the effectiveness and adaptability of the system 801.

FIG. 9 is a flowchart illustrating a method for real-time asset validation of connected devices in an operation technology (OT) infrastructure, in accordance with an embodiment of the present disclosure. At operation 901, the method 900 discloses monitoring a plurality of parameters associated with the connected devices in the OT infrastructure. The plurality of parameters may at least comprise device critical parameters, cybersecurity parameters, and functional safety parameters. In one non-limiting embodiment, the processor 803 may be configured to monitor one or more parameters actively by interacting with the live systems/device and monitor remaining of the plurality of parameters passively without interacting with the live system/devices.

The plurality of parameters may include voltage and power configuration parameters, network traffic and bandwidth, performance metrics, error rates and alarms, device health and status, security events, communication integrity data, firmware and software versions, access and authentication logs, and maintenance schedule data. However, the plurality of parameters is not restricted to the above examples, and other parameters related to devices within the plant in OT infrastructure is well within the scope of the present disclosure. In one non-limiting embodiment, the plurality of parameters may be classified into device critical parameters, cybersecurity parameters, and functional safety parameters, as discussed in the above embodiments.

At operation 903, the method 900 discloses applying at least one natural language processing (NLP) model on one or more parameter, among a first set of the plurality of monitored parameters to extract textual information. The extraction of textual information may be performed as discussed in the above embodiments. The first set of the plurality of monitored parameters includes at least one of software bill of materials (SBOM), audit logs, system logs and event logs, device critical parameter logs, device behavior data. The first set of the plurality of monitored parameters are passively monitored without interacting with live system. Thus, these parameters contribute towards determination of the passive security posture.

In an embodiment, the NLP model may be trained with plurality of training dataset associated with similar plant environment for extraction of the textual information from the plurality of training dataset. In one non-limiting embodiment of the present disclosure, the NLP model may be retrained based on the feedback received from the administrator. The retraining may include receiving feedback on the extracted textual information, applying the feedback on the training dataset to generate an updated training dataset and retraining the NLP model based on the updated training dataset. The retrained NLP model may improve the accuracy of the vulnerability and/or anomaly detection.

At operation 905, the method 900 discloses performing feature extraction using Extended Berkeley Packet Filter (eBPF) on a second set of the plurality of monitored parameters. The second set of the plurality of monitored parameters includes at least one of low-level system data and network activity information taken from the connected devices in the OT infrastructure.

At operation 907, the method 900 discloses integrating the extracted textual information with the extracted features. In an embodiment, most of the extracted textual information and the extracted features are in json/xml format. The integration may include the conversion of the extracted features which are not in json/xml format into json/xml format using a parser.

At operation 909, the method 900 discloses comparing the integrated information with vulnerabilities and abnormal behavior-based signatures. At operation 911, the method 900 discloses detecting vulnerability and/or anomaly based on the comparison. The vulnerabilities and abnormal behavior-based signatures may be generated based on the known vulnerabilities and abnormal behaviors identified in historical data. These signatures may be then used to detect anomalies/vulnerabilities in the real-time data. In one non-limiting embodiment, the vulnerabilities and abnormal behavior-based signatures are dynamically updated based on the evolving threat landscape. This is achieved by actively monitoring the new vulnerabilities and abnormal behaviors in the OT environment. In another non-limiting embodiment, the vulnerabilities and abnormal behavior-based signatures may be customized by the user for specific threats relevant to their OT environment.

In one non-limiting embodiment, the method 900 discloses detecting vulnerability and/or anomaly using machine learning (ML) model for detecting anomalies/vulnerabilities in the real-time data. The ML model may be an adaptive machine learning model for detecting anomalies/vulnerabilities. The ML model may be trained with vulnerabilities and abnormal behavior-based signatures, which were observed previously. The ML model may receive expert administrator feedback on the detected anomalies/vulnerabilities to distinguish between false positives and actual threats. The feedback may be incorporated into the dataset to train the ML model. Further, the ML model may be trained at regular intervals to improve the accuracy of the anomalies/vulnerabilities detection. In one non-limiting embodiment, supervised learning, unsupervised learning, and reinforcement learning may be used for training the adaptive machine learning model, as discussed in above embodiments.

The method 900 further discloses retrieving a plurality of mitigation strategies from one or more external sources and recommends at least one mitigation strategy for the detected vulnerability and/or anomaly. In one non-limiting embodiment, the expert administrator may implement the mitigation strategy for the detected vulnerability and/or anomaly.

In one non-limiting aspect, the method 900 further discloses determining values of the device critical parameters and the cybersecurity parameters based on the monitoring, assigning a weight to each of the device critical parameters and the cybersecurity parameters, and calculating plant security score based on the values of the device critical parameters, the cybersecurity parameters, and the assigned weights. The plant security score may be then used to calculate the overall plant security posture. This may help the plant owner to improve the plant security posture, as discussed in the above embodiments.

In an embodiment, a flexible dynamic scoring system may be provided to the plant owners flexibility to add weights in the parameters. Consider protection and control parameters (device critical parameters) as DC and cybersecurity parameters as SP. The plant owner adding weights in DC=(DC1×W1)+(DC2×W2) . . . and plant owner adding weights in SP=(SP1×U1)+(SP2×U2) . . . . Then, plant security score (PSS) may be calculated based on equation (6) discussed above. In one non-limiting of the present disclosure, the user/plant owner may decide on the percentage for device critical parameters and cybersecurity parameters.

Thus, the method 900 provides a comprehensive, adaptive, and integration of device critical parameters as an efficient solution to cybersecurity challenges compared to traditional approaches. Further, the method 900 integrates diverse data sources, analyze complex information, and continuously learn from expert feedback, thereby enhancing threat detection and mitigation capabilities, and making it a valuable asset in cybersecurity defense strategies. In addition, expert feedback collection, periodic model re-training, and dynamic signature updates ensure the effectiveness and adaptability of the system.

In an embodiment of the present disclosure, ML models 209, 807 and NLP models 703, 813 may be integrated with each other to provide passive multi layered approach for calculating cyber security postures and to provide real-time monitoring and live asset validation of connected devices with proactive cyber security posture scoring.

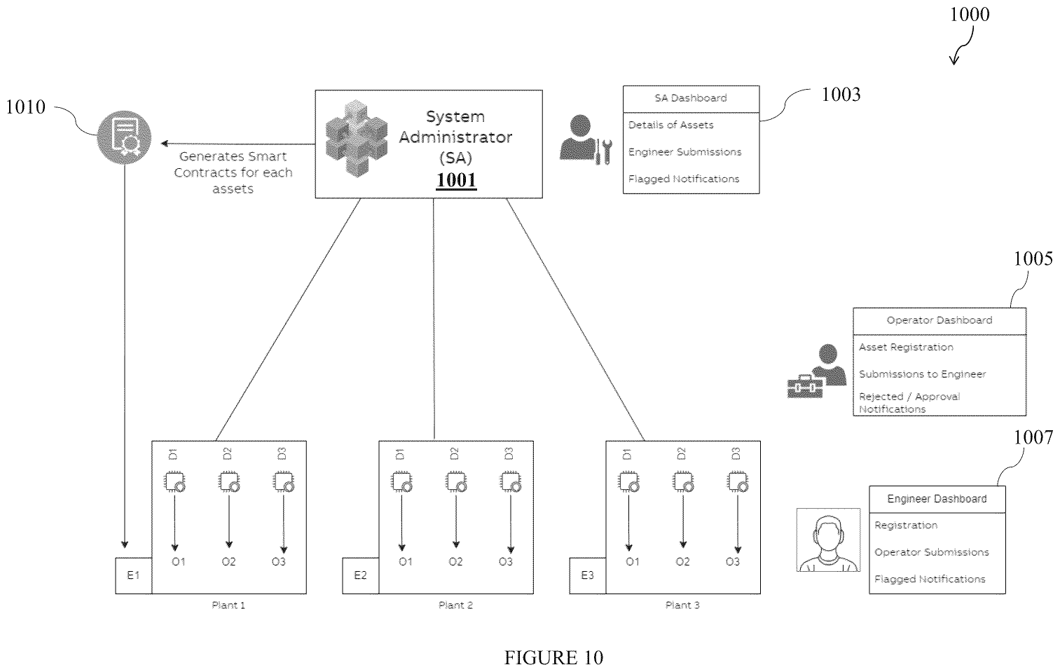

FIG. 10 illustrates a block diagram 1000 representation of asset integrity verification, in accordance with an embodiment of the present disclosure.

As shown in FIG. 10, an OT infrastructure may comprise a plurality of plants (P1, P2, . . . Pn) may comprise a plurality of devices (D1, D2, . . . Dn). Each device may have a respective operator (O1, O2, . . . On) mapped to it. Each plant may have an engineer (E1, E2, . . . En) assigned to it.

In an embodiment, a smart contract 1010 is deployed to manage the registration of devices (D1, D2, . . . Dn). This includes logic for verification and approval. A system administrator 1001 (or expert administrator) approves node acceptance as per the data submitted by the Plant's engineer (E1, E2, . . . En). Once the approval is given, a smart contract is generated for that asset which cannot be modified by engineer or operator. O1 provides the necessary details to engineer E1. E1 verifies the details and initiates the registration process on the blockchain and sends it to System Administrator for approval and node creation.

In one embodiment, a node registration may require an operator O1 wants to register a new device, D1, in plant P1. The smart contract 1010 validates the details provided by O1/E1 and checks for any duplicates or discrepancies. If the details are accurate, D1 is added to the blockchain as a node associated with plant P1. Similar steps may be performed to add a node/device of a respective plant.

In an embodiment, the System Administrator (SA) 1001, sitting at the SA dashboard 1003, receives a real-time notification about the device registration. The SA dashboard 1003 displays information such as the device ID (D1), operator (O1), plant (P1), and timestamp of the registration. In one non-limiting aspect, the SA dashboard 1003 may display details of the asset, engineer submission, and flagged notifications. The SA 1001 continues to monitor the blockchain for any changes made by operators, engineers, or any potential malicious activity.

In case the operator O1 or a malicious actor M attempts to make unauthorized changes to the details of Device D1, the smart contract detects the unauthorized attempt and prevents the changes from being recorded on the blockchain. The SA dashboard 1003 may generate a notification about the attempted unauthorized change, providing details of the event. The SA 1001 may investigate the incident, taking appropriate actions to address the security threat or inform relevant parties.

As shown in FIG. 10, the engineer dashboard 1007 may indicate the device registration feature, operator submissions, and flagged notification. Similarly, the operator dashboard 100 may indicate the asset registration information, submissions to engineers, and rejected/approved notifications.

Thus, the asset integrity verification facilitates preventing any unintentional configuration change by any user including operator/malicious actor by generating an alert for the changes in any configuration parameter in device, which would reduce the device security.

Various embodiments of the present disclosure provide numerous advantages. Embodiments of the present disclosure provide a system for analyzing cybersecurity postures for an operation technology infrastructure. In addition, the present disclosure provides the system for generating a prioritization sequence for remediation of one or more vulnerable components of each plant.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

### LIST OF REFERENCE SYMBOLS

| Referral Number | Description |
|---|---|
| 100 | Block diagram representation |
| 101 | Critical infrastructure or Operation technology |
| | infrastructure |
| 103 | Plant |
| 105 | Plurality of devices |
| 107 | Plurality of levels |
| 109 | Demilitarized zone (DMZ) |
| 200 | Schematic representation |
| 201 | Plurality of plants |
| 203 | Severity calculation module |
| 205 | Score calculation module |
| 206 | CICPS (Critical infrastructure cybersecurity |
| | posture score) |
| 209 | Machine learning model |
| 211 | One or more databases |
| 213 | Predicted output |
| 300 | Block diagram representation |
| 215 | One or more external sources |
| 217 | Extracted information |
| 219 | Classification module |
| 221 | Classification database |
| 400 | Block diagram |
| 401 | System |
| 403 | Processor |
| 4405 | Memory |
| 500a | Method |
| 501a-511a | Method steps |
| 500b | Method |
| 501b-513b | Method steps |
| 600 | Method |
| 601-607 | Method steps |
| 700 | Block Diagram |
| 701 | Plurality of sources |
| 703 | NLP Model |
| 705 | eBPF agent |
| 707 | Vulnerability and Anomaly Detection Unit |
| 709 | Signature Management Unit |
| 710 | Expert Administrator |
| 711 | Detected Vulnerability/Anomaly |
| 712 | Security Scoring Unit |
| 713 | Mitigation Unit |
| 715 | Mitigation Strategy |
| 800 | Block Diagram |
| 801 | System |
| 803 | Processor |
| 805 | Memory |
| 807 | Machine Learning Model |
| 809 | Scoring Unit |
| 811 | eBPF agent |
| 813 | NLP Model |
| 900 | Method |
| 901-911 | Method steps |
| 1000 | Asset Integrity Verification block diagram |
| 1001 | System Administrator |
| 1003 | System Administrator Dashboard |
| 1005 | Operator Dashboard |
| 1007 | Engineer Dashboard |
| 1010 | Smart Contract |

What is claimed is:

1. A method for analyzing cybersecurity posture for an operation technology (OT) infrastructure, the method comprising:
categorizing a plurality of devices of one or more plants of the OT infrastructure into a plurality of levels, based on an exposure of each device to a communication network;
identifying one or more common vulnerabilities and exposures (CVEs) of components of the plurality of devices, at each level, utilizing Bill of Material (BoM) corresponding to each device;
assigning a severity value to the one or more CVEs of components of the plurality of devices present at each level, based on one or more databases, wherein the one or more databases are associated with vulnerability;
calculating a sum of severities based on the number of CVEs of components of the plurality of devices present at each level and the associated severity values;
determining a plant cybersecurity posture score (PCPS) for the one or more plants based on the sum of severities, a number of devices in each level, and a compensation value; and
computing a critical infrastructure cybersecurity posture score (CICPS) for the OT infrastructure based on the determined PCPS of the one or more plants.

2. The method of claim 1, wherein the compensation value varies based on a number of devices categorized in each level.

3. The method of claim 1, wherein the compensation value is determined based on a priority factor associated with the one or more plants.

4. The method of claim 1, wherein the plurality of levels indicates vulnerability, of the plurality of devices, to a cyber threat, and wherein the vulnerability to the cyber threat increases with the increase in the level.

5. The method of claim 1, wherein the cybersecurity posture score for the one or more plants is determined based on
$$F ( PCPS ) = \frac{1}{{\sum }_{i = 0}^{4} XiSi} + C ,$$
where F(PCPS) corresponds to the plant cybersecurity posture score of a plant, Xi corresponds to a level of the plurality of levels, Si corresponds to the sum of severities, and C corresponds to the compensation value.

6. A method for prioritizing remediation of common vulnerabilities and exposures (CVEs) of components of a plurality of devices, the method comprising:
receiving a critical infrastructure cybersecurity posture score (CICPS) of an OT infrastructure;
retrieving classification of the one or more CVEs of components of the plurality of devices from a classification database;
generating a prioritization sequence for remediation of one or more vulnerable components of each plant based on the classification of the one or more CVEs of components; and
applying remediation to the one or more vulnerable components based on the generated prioritization sequence to modify the CICPS (206) of the OT infrastructure.

7. The method as claimed in claim 6, further comprising:
extracting information associated with the one or more CVEs of components of each device from Bill of Material (BoM) corresponding to each device;
retrieving one or more remediation strategies associated with the one or more CVEs of components from one or more external sources;
classifying the one or more CVEs of components based on the critical infrastructure cybersecurity posture score, the extracted information and one or more retrieved remediation strategies; and
storing the classification of one or more CVEs of components of each device in the classification database.

8. The method as claimed in claim 6, further comprising:
training a machine learning (ML) model based on the classification of the one or more CVEs of components of the plurality of devices;
wherein generating the prioritization sequence for remediation of the one or more vulnerable components of each plant comprises generating the prioritization sequence for remediation of the one or more vulnerable components of each plant based on the trained ML model.

9. A system to analyze cybersecurity posture for an operation technology (OT) infrastructure comprises:
a memory;
at least one processor coupled to the memory and is configured to:
categorize a plurality of devices of one or more plants of the OT infrastructure into plurality of levels, based on an exposure of each device to a communication network;
identify one or more common vulnerabilities and exposures (CVEs) of components of the plurality of devices, at each level, utilizing Bill of Material (BoM) corresponding to each device;
assign a severity value to the one or more CVEs of components of the plurality of devices present at each level, based on one or more databases, wherein the one or more databases are associated with vulnerability;
calculate a sum of severities based on the number of CVEs of components of the plurality of devices present at each level and the associated severity values;
determine a plant cybersecurity posture score (PCPS) for the one or more plants based on the sum of severities, a number of devices in each level, and a compensation value; and
compute a critical infrastructure cybersecurity posture score (CICPS) for the OT infrastructure based on the determined PCPS of the one or more plants.

10. The system of claim 9, wherein the at least one processor is configured to vary the compensation value based on a number of devices categorized in each level.

11. The system of claim 9, wherein the at least one processor is configured to determine the compensation value based on a priority factor associated with the one or more plants.

12. The system of claim 9, wherein the plurality of levels indicates vulnerability, of the plurality of devices, to a cyber threat, and wherein the vulnerability to the cyber threat increases with the increase in the level.

13. A system to analyze cybersecurity posture for an operation technology (OT) infrastructure, the system comprising:
a memory;
at least one processor coupled to the memory and is configured to:
receive a critical infrastructure cybersecurity posture score (CICPS) of the OT infrastructure;
retrieve classification of one or more CVEs of components of the plurality of devices from a classification database;
generate a prioritization sequence for remediation of one or more vulnerable components of each plant based on the classification of the one or more CVEs of components; and
apply remediation to the one or more vulnerable components based on the generated prioritization sequence to modify the CICPS (206) of the OT infrastructure.

14. The system of claim 13, wherein the at least one processor is further configured to:
extract information associated with the one or more CVEs of components of each device from Bill of Material (BoM) corresponding to each device;
retrieve one or more remediation strategies associated with the one or more CVEs of components from one or more external sources;
classify the one or more CVEs of components based on the critical infrastructure cybersecurity posture score, the extracted information and one or more retrieved remediation strategies; and
store the classification of one or more CVEs of components of each device in the classification database.

15. The system of claim 13, wherein the at least one processor is further configured to:
train a machine learning (ML) model based on the classification of the one or more CVEs of components of the plurality of devices,
wherein to generate the prioritization sequence for remediation of the one or more vulnerable components of each plant, the at least one processor is configured to generate the prioritization sequence for remediation of the one or more vulnerable components of each plant based on the trained ML model.

16. A method for real-time asset validation of connected devices in an operation technology (OT) infrastructure, the method comprising:
monitoring a plurality of parameters associated with the connected devices in the OT infrastructure, wherein the plurality of parameters at least comprises device critical parameters, cybersecurity parameters, and functional safety parameters;
applying at least one natural language processing (NLP) model on one or more parameter, among a first set of the plurality of monitored parameters to extract textual information, wherein the first set of the plurality of monitored parameters include at least one of software bill of materials (SBOM), audit logs, system logs and event logs, device critical parameter logs, device behavior data;
performing feature extraction using Extended Berkeley Packet Filter (eBPF) on a second set of the plurality of monitored parameters, wherein the second set of the plurality of monitored parameters include at least one of low-level system data and network activity information from the connected devices;
integrating the extracted textual information with the extracted features;
comparing the integrated information with vulnerabilities and abnormal behavior based signatures; and
detecting vulnerability and/or anomaly based on the comparison.

17. The method as claimed in claim 16, further comprising:
retrieving a plurality of mitigation strategies from one or more external sources; and
recommending at least one mitigation strategy for the detected vulnerability and/or anomaly.

18. The method as claimed in claim 16, further comprising generating the vulnerabilities and abnormal behavior-based signatures based on vulnerabilities and abnormal behaviors identified in historical data.

19. The method as claimed in claim 18, further comprising dynamically updating the vulnerabilities and abnormal behavior-based signatures based on evolving threat landscape.

20. The method as claimed in claim 16, further comprising:
receiving, from an administrator, feedback on the detected vulnerability and/or anomaly;
applying the feedback on at least one training dataset to generate an updated training dataset; and
retraining the NLP model with the updated training dataset.

21. The method as claimed in claim 16, further comprising:
determining values of the device critical parameters and the cybersecurity parameters based on the monitoring;
assigning a weight to each of the device critical parameters and the cybersecurity parameters; and
calculating plant security score based on the values of the device critical parameters, the cybersecurity parameters, and the assigned weights.

22. A system for real-time asset validation of connected devices in an operation technology (OT) infrastructure, the system comprising:
a memory;
at least one processor coupled to the memory and is configured to:
monitor a plurality of parameters associated with the connected devices in the OT infrastructure, wherein the plurality of parameters at least comprises device critical parameters, cybersecurity parameters, and functional safety parameters;
apply at least one natural language processing (NLP) model on one or more parameter, among a first set of the plurality of monitored parameters to extract textual information, wherein the first set of the plurality of monitored parameters include at least one of software bill of materials (SBOM), audit logs, system logs and event logs, device critical parameter logs, device behavior data;
perform feature extraction using Extended Berkeley Packet Filter (eBPF) on a second set of the plurality of monitored parameters, wherein the second set of the plurality of monitored parameters include at least one of low-level system data and network activity information from the connected devices;
integrate the extracted textual information with the extracted features;
compare the integrated information with vulnerabilities and abnormal behavior based signatures; and
detect vulnerability and/or anomaly based on the comparison.

23. The system as claimed in claim 22, wherein the at least one processor is configured to:
retrieve a plurality of mitigation strategies from one or more external sources; and
recommend at least one mitigation strategy for the detected vulnerability and/or anomaly.

24. The system as claimed in claim 22, wherein the at least one processor is configured to generate the vulnerabilities and abnormal behavior based signatures based on vulnerabilities and abnormal behaviors identified in historical data.

25. The system as claimed in claim 24, wherein the at least one processor is configured to dynamically update the vulnerabilities and abnormal behavior based signatures based on evolving threat landscape.

26. The system as claimed in claim 22, wherein the at least one processor is configured to:
receive, from an administrator, feedback on the detected vulnerability and/or anomaly;
apply the feedback on at least one training dataset to generate an updated training dataset; and
retrain the NLP model with the updated training dataset.

27. The system as claimed in claim 22, wherein the at least one processor is configured to:
determine values of the device critical parameters and the cybersecurity parameters based on the monitoring;
assign a weight to each of the device critical parameters and the cybersecurity parameters; and
calculate plant security score based on the values of the device critical parameters, the cybersecurity parameters, and the assigned weights.

28. A method for analyzing cybersecurity posture for an operation technology (OT) infrastructure, the method comprising:
defining at least one critical infrastructure with one or more plants;
categorizing a plurality of devices of the one or more plants of the OT infrastructure into a plurality of levels, based on an exposure of each device to a communication network;
identifying one or more common vulnerabilities and exposures (CVEs) of components of the plurality of devices, utilizing Bill of Material (BoM) corresponding to each device;
assigning a severity value to the one or more CVEs of components of the plurality of devices, based on one or more databases, the one or more databases being associated with vulnerability, and wherein each severity value is mapped with a respective predefined severity weight;
calculating a device level score for each of the plurality of devices at least based on the assigned severity values and corresponding predefined severity weights;
determining a plant cybersecurity posture score for the one or more plants based on the device level score of each device, a level-based multiplication factor of each device, and number of devices in each level; and
computing a critical infrastructure cybersecurity posture score for the OT infrastructure based on the determined plant cybersecurity posture score of the one or more plants and assigned priority of each plant.

29. The method of claim 28, wherein defining at least one critical infrastructure with one or more plants comprises receiving a user input comprising a number of critical infrastructures, a number of plants in each critical infrastructure, a number of devices present in each plant, priority of each plant, and level information of each device.

30. The method of claim 28, wherein a severity weight is predefined for a range of severity values based on a user input.

31. The method of claim 28, wherein the level-based multiplication factor is predefined for each level of the plurality of levels.

32. The method of claim 28, wherein the device level score is calculated based on
$${S}_{d} = 100 - \frac{( {\sum }_{i}^{n} V {D}_{i} \times W {L}_{i} ) \times 100}{( {\sum }_{i} W {L}_{i} ) \times 10 + ∈} ,$$
where S_{d} corresponds to the device level score, VDᵢ corresponds to the severity value, WLᵢ corresponds to the predefined severity weight, and ∈ corresponds to a constant value.

33. The method of claim 28, wherein the plant cybersecurity posture score is determined based on
$${S}_{p} = ( \frac{{\sum }_{i}^{5} d \times ( {Sd}_{i} \times {W}_{Lsdi} )}{100 \times ( {\sum }_{L} ( {W}_{L} \times No of {devices}_{L} ) ) + ∈} ) \times 100 ,$$
where Sₚ corresponds to the plant cybersecurity posture score, Sdᵢ corresponds to the device level score of each device present in the plant, WLSdᵢ corresponds to the level based multiplication factor, and ∈ corresponds to a constant value.

34. The method of claim 28, wherein the critical infrastructure cybersecurity posture score is computed based on
$${S}_{ci} = ( \frac{{\sum }_{p} ( {S}_{p} \times {priority}_{p} )}{100 \times ( {\sum }_{p} ( p \times No of plants with {priority}_{p} ) ) + ∈} ) \times 100 ,$$
where S_{ci} corresponds to the plant cybersecurity posture score, Spᵢ corresponds to the plant cybersecurity posture score of the critical infrastructure, priorityₚ corresponds to the priority assigned to each plant, and ∈ corresponds to a constant value.
